(19) United States
(12) Patent Application Publication
(10) Pub. No.: US 2024/0105383 A1
(43) Pub. Date: Mar. 28, 2024

(54) MULTILAYER COIL COMPONENT

(71) Applicant: Murata Manufacturing Co., Ltd., Kyoto-fu (JP)

(72) Inventor: Shoyo YAMADA, Nagaokakyo-shi (JP)

(73) Assignee: Murata Manufacturing Co., Ltd., Kyoto-fu (JP)

(21) Appl. No.: 18/469,594

(22) Filed: Sep. 19, 2023

(30) Foreign Application Priority Data
Sep. 20, 2022 (JP) 2022-149094

(51) Int. Cl. H01F 27/32; H01F 17/00

(52) U.S. Cl. CPC H01F 27/32; H01F 17/0013

(57) ABSTRACT

A multilayer coil component includes a multilayer body and outer electrodes. The multilayer body includes insulating layers and a coil. The insulating layers are stacked on top of one another in a stacking direction. The coil is embedded in the multilayer body. The outer electrodes are on an outer surface of the multilayer body and are electrically connected to the coil. The coil includes coil conductors, which are stacked together with the insulating layers in the stacking direction and electrically connected to each other. The coil includes a parallel section in which two or more of the coil conductors stacked in layers are electrically connected in parallel by via conductors interposed therebetween. The parallel section includes a first parallel section and a second parallel section, which is electrically connected in series with the first parallel section.

### CROSS-REFERENCE TO RELATED APPLICATION

This application claims benefit of priority to Japanese Patent Application No. 2022-149094, filed Sep. 20, 2022, the entire content of which is incorporated herein by reference.

### BACKGROUND

### Technical Field

The present disclosure relates to a multilayer coil component.

### Background Art

A multilayer inductor disclosed in Japanese Unexamined Patent Application Publication No. 2008-53368 includes a multilayer body, a first outer electrode, a second outer electrode, and conductor portions. The multilayer body includes insulating layers stacked on top of one another. The first and second outer electrodes are disposed on an outer surface of the multilayer body. The conductor portions are arranged in a stacking direction in which the insulating layers are stacked on top of one another. The conductor portions are each connected in series between the first outer electrode and the second outer electrode. The conductor portions include a first conductor portion and a second conductor portion. The first conductor portion includes at least two first conductor patterns. The second conductor portion includes one second conductor pattern. The at least two first conductor patterns have the same shape and are arranged in the stacking direction to form a string of conductor patterns in the stacking direction. The at least two first conductor patterns each have an end electrically connected to the first outer electrode, and the other ends of the at least two first conductor patterns are electrically connected to each other such that the at least two first conductor patterns are connected in parallel. One end of the second conductor pattern is electrically connected to the second outer electrode. The other end of the second conductor pattern is electrically connected to the first outer electrode with the at least two first conductor patterns therebetween.

An electronic component disclosed in Japanese Unexamined Patent Application Publication No. 2014-157919 includes a multilayer body, a coil, and outer electrodes. The multilayer body includes insulating layers stacked on top of one another. The coil is disposed in the multilayer body and includes coil conductors connected by via conductors extending through the insulating layers. The coil winds helically about an axis in a stacking direction in which the insulating layers are stacked on top of one another. The outer electrodes are disposed on a surface of the multilayer body. At least some pairs of the coil conductors lying on top of each other with one of the insulating layers therebetween each have parallel-running sections in which the coil conductors winding helically overlap each other when viewed in the stacking direction. The parallel-running sections are connected in parallel by the via conductors or the outer electrodes. When viewed in the stacking direction, coil conductors of each pair of coil conductors lying on top of each other with one of the insulator layers therebetween do not overlap each other in a region other than the parallel-running sections and connection portions where the coil conductors are connected to the via conductors.

The multilayer inductor disclosed in Japanese Unexamined Patent Application Publication No. 2008-53368 includes pattern groups connected in series and each including at least two conductor patterns connected in parallel. For example, two parallel sections in which two coil conductors connected in parallel are located on different insulating layers as illustrated in, for example, FIG. 2 in Japanese Unexamined Patent Application Publication No. 2008-53368. In such a structure, via conductors stacked in the stacking direction become greater in volume. Consequently, the via conductors exert greater stress on the insulating layers and can cause defects such as cracking in the multilayer body.

With regard to an electronic component disclosed to Japanese Unexamined Patent Application Publication No. 2014-157919, it is required that when viewed in the stacking direction, coil conductors of each pair of coil conductors lying on top of each other with an insulating layer therebetween do not overlap each other in a region other than the parallel-running sections and the connection portions where the coil conductors are connected to the via conductors. In this case, the impedance acquisition efficiency per insulating layer would be limited due to limitations on the length of the coil conductor in each insulating layer.

### SUMMARY

Accordingly, the present disclosure provides a multilayer coil component with a lower incidence of defects such as cracking in a multilayer body and with high impedance acquisition efficiency.

A multilayer coil component according to the present disclosure includes a multilayer body and outer electrodes. The multilayer body includes insulating layers and a coil. The insulating layers are stacked on top of one another in a stacking direction. The coil is embedded in the multilayer body. The outer electrode is disposed on an outer surface of the multilayer body and is electrically connected to the coil. The coil is composed of coil conductors stacked together with the insulating layers in the stacking direction and electrically connected to each other. The coil includes a parallel section in which two or more of the coil conductors stacked in layers are electrically connected in parallel by via conductors interposed therebetween. The parallel section includes a first parallel section and a second parallel section that is electrically connected in series with the first parallel section. One of the coil conductors included in the first parallel section and one of the coil conductors included in the second parallel section are connected directly to each other in one plane on a first insulating layer that is one of the insulating layers. When viewed in the stacking direction, the coil conductors lying on top of each other with the first insulating layer therebetween at least partially overlap each other in a region other than the parallel section in which the coil conductors lying on top of each other with the first insulating layer therebetween are connected in parallel and overlap each other.

According to the present disclosure, a multilayer coil component with a lower incidence of defects such as cracking in a multilayer body and with high impedance acquisition efficiency can be provided.

### BRIEF DESCRIPTION OF THE DRAWINGS

FIG. 1 is a schematic perspective view of an example of a multilayer coil component according to a first embodiment of the present disclosure;

FIG. 2 is a schematic plan view of an example of a multilayer body included in the multilayer coil component according to the first embodiment of the present disclosure;

FIG. 3 is an exploded perspective view of a coil embedded in the multilayer body in FIG. 2;

FIG. 4-1 is a schematic plan view of a path in a parallel section P1a of a coil 30A in FIG. 3;

FIG. 4-2 is a schematic plan view of a path in a parallel section P2a of the coil 30A in FIG. 3;

FIG. 4-3 is a schematic plan view of a path in a parallel section P1b of the coil 30A in FIG. 3;

FIG. 4-4 is a schematic plan view of a path in a parallel section P2b of the coil 30A in FIG. 3;

FIG. 5 is a schematic development view of an example of the coil included in the multilayer coil component according to the first embodiment of the present disclosure;

FIG. 6 is a schematic development view of an example of a coil included in a conventional multilayer coil component;

FIG. 7 is a schematic plan view of an example of a multilayer body included in a multilayer coil component according to a second embodiment of the present disclosure;

FIG. 8 is an exploded perspective view of a coil embedded in the multilayer body in FIG. 7;

FIG. 9-1 is a schematic plan view of a path in a parallel section P1a of a coil 30B in FIG. 8;

FIG. 9-2 is a schematic plan view of a path in a parallel section P2a of the coil 30B in FIG. 8;

FIG. 9-3 is a schematic plan view of a path in a parallel section P1b of the coil 30B in FIG. 8;

FIG. 9-4 is a schematic plan view of a path in a parallel section P2b of the coil 30B in FIG. 8;

FIG. 10 is a schematic plan view of an example of a multilayer body included in a multilayer coil component according to a third embodiment of the present disclosure;

FIG. 11 is an exploded perspective view of a coil embedded in the multilayer body in FIG. 10;

FIG. 12-1 is a schematic plan view of a path in a parallel section P1a of a coil 30C in FIG. 11;

FIG. 12-2 is a schematic plan view of a path in a parallel section P2a of the coil 30C in FIG. 11;

FIG. 12-3 is a schematic plan view of a path in a parallel section P1b of the coil 30C in FIG. 11;

FIG. 12-4 is a schematic plan view of a path in a parallel section P2b of the coil 30C in FIG. 11;

FIG. 12-5 is a schematic plan view of a path in a parallel section P1c of the coil 30C in FIG. 11;

FIG. 12-6 is a schematic plan view of a path in a parallel section P2c of the coil 30C in FIG. 11;

FIG. 12-7 is a schematic plan view of a path in a parallel section P1d of the coil 30C in FIG. 11;

FIG. 12-8 is a schematic plan view of a path in a parallel section P2d of the coil 30C in FIG. 11;

FIG. 12-9 is a schematic plan view of a path in a parallel section P1e of the coil 30C in FIG. 11;

FIG. 12-10 is a schematic plan view of a path in a parallel section P2e of the coil 30C in FIG. 11;

FIG. 12-11 is a schematic plan view of a path in a parallel section P1f of the coil 30C in FIG. 11;

FIG. 13 is a schematic plan view of an example of a multilayer body included in a multilayer coil component according to a fourth embodiment of the present disclosure;

FIG. 14 is an exploded perspective view of a coil embedded in the multilayer body in FIG. 13;

FIG. 15-1 is a schematic plan view of a path in a parallel section P1a of a coil 30D in FIG. 14;

FIG. 15-2 is a schematic plan view of a path in a parallel section P2a of the coil 30D in FIG. 14;

FIG. 15-3 is a schematic plan view of a path in a parallel section P1b of the coil 30D in FIG. 14;

FIG. 15-4 is a schematic plan view of a path in a parallel section P2b of the coil 30D in FIG. 14;

FIG. 15-5 is a schematic plan view of a path in a parallel section P1c of the coil 30D in FIG. 14;

FIG. 15-6 is a schematic plan view of a path in a parallel section P2c of the coil 30D in FIG. 14;

FIG. 15-7 is a schematic plan view of a path in a parallel section P1d of the coil 30D in FIG. 14;

FIG. 15-8 is a schematic plan view of a path in a parallel section P2d of the coil 30D in FIG. 14;

FIG. 15-9 is a schematic plan view of a path in a parallel section P1e of the coil 30D in FIG. 14;

FIG. 15-10 is a schematic plan view of a path in a parallel section P2e of the coil 30D in FIG. 14;

FIG. 15-11 is a schematic plan view of a path in a parallel section P1f of the coil 30D in FIG. 14;

FIG. 16 is a schematic plan view of an example of a multilayer body included in a multilayer coil component according to a fifth embodiment of the present disclosure;

FIG. 17 is an exploded perspective view of a coil embedded in the multilayer body in FIG. 16;

FIG. 18-1 is a schematic plan view of a path in a parallel section P1a of a coil 30E in FIG. 17;

FIG. 18-2 is a schematic plan view of a path in a parallel section P2a of the coil 30E in FIG. 17;

FIG. 18-3 is a schematic plan view of a path in a parallel section P1b of the coil 30E in FIG. 17;

FIG. 18-4 is a schematic plan view of a path in a parallel section P2b of the coil 30E in FIG. 17;

FIG. 18-5 is a schematic plan view of a path in a parallel section P1c of the coil 30E in FIG. 17;

FIG. 19 is a schematic development view of an example of a coil included in a multilayer coil component according to another embodiment of the present disclosure; and

FIG. 20 is a schematic development view of another example of the coil included in the conventional multilayer coil component.

### DETAILED DESCRIPTION

The following describes a multilayer coil component according to the present disclosure. The following should not be construed as limiting the configuration of the present disclosure, which may be modified as appropriate to the extent that the gist of the present disclosure is unchanged. It should be noted that varying combinations of two or more desired features, which will be described below, are also embraced by the present disclosure.

The words (e.g., vertical, parallel, perpendicular) hereinafter used to describe the relationship between elements and the words hereinafter used to describe the shapes of elements should not necessarily be interpreted in the strict sense and can be understood as meaning that a margin of several percent is acceptable as substantial equivalence.

One of the features of the multilayer coil component according to the present disclosure is as follows. The multilayer coil component incorporates a coil including a parallel section. The parallel section includes a first parallel section and a second parallel section that is electrically connected in series with the first parallel section. One of coil conductors in the coil included in the first parallel section and one of the coil conductors included in the second parallel section are connected directly to each other in one plane on a first insulating layer that is one of insulating layers included in the multilayer coil component. This feature, namely, the structure in which one of the coil conductors included in the first parallel section and one of the coil conductors included in the second parallel section are located on the same insulating layer is advantageous in that the via conductors disposed on top of each other in the stacking direction are fewer in number than in a comparative structure in which each of coil conductors in the first parallel section and each of the coil conductors in the second parallel section are disposed on different insulating layers. This feature is advantageous in that there is a lower incidence of defects such as cracking. The expression “connected directly to” in the description refers not only to direct connection between coil conductors included in the respective parallel sections but also to connection formed between the coil conductors with lands therebetween.

Another feature of the multilayer coil component according to the present disclosure is as follows: when viewed in the stacking direction, the coil conductors lying on top of each other with the first insulating layer therebetween at least partially overlap each other in a region other than the parallel section in which the coil conductors lying on top of each other with the first insulating layer therebetween are connected in parallel and overlap each other. This feature is advantageous in that the coil conductors can be formed in such a manner as to increase the total length of the first and second parallel sections. Accordingly, a coil with high impedance acquisition efficiency can be provided. The expression “parallel sections connected in parallel” in the description refers to a region including the lands.

As mentioned above in relation to the multilayer coil component according to the present disclosure, one of the coil conductors included in the first parallel section and one of the coil conductors included in the second parallel section are connected directly to each other on the first insulating layer, whereas the other coil conductor included in the first parallel section (a coil conductor being one of the coil conductors in the first parallel section and not disposed on the first insulating layer) and the other coil conductor included in the second parallel section (a coil conductor being one of the coil conductors in the second parallel section and not disposed on the first insulating layer) may be disposed on different insulating layers.

With regard to the multilayer coil component according to the present disclosure, the first parallel section and the second parallel section viewed in the stacking direction may be arranged with or without an overlap therebetween.

With regard to the multilayer coil component according to the present disclosure, the number of coil conductors constituting the parallel section including the first parallel section and the second parallel section is not limited to a particular value. The coil conductors constituting the first parallel section included in the parallel section and the coil conductors constituting the second parallel section included in the parallel section are preferably equal in number. For example, the first parallel section and the second parallel section included in the parallel section may each be composed of two coil conductors stacked in layers. In this case, the maximum number of via conductors disposed on top of each other with no other via conductors interposed therebetween in the stacking direction can be reduced from three to two. Alternatively, the first parallel section and the second parallel section included in the parallel section may each be composed of three coil conductors stacked in layers. In this case, the maximum number of via conductors disposed on top of each other with no other via conductors interposed therebetween in the stacking direction can be reduced from five to three. Still alternatively, the first parallel section and the second parallel section included in the parallel section may each be composed of four or more coil conductors stacked in layers.

With regard to the multilayer coil component according to the present disclosure, it is preferred that the proportion of a path in the first parallel section to a path corresponding to one turn of the coil be not equal to the proportion of a path in the second parallel section to the path corresponding to one turn of the coil, although the proportion of the path in the first parallel section to the path corresponding to one turn of the coil may be equal to the proportion of the path in the second parallel section to the path corresponding to one turn of the coil.

As described below in relation to the embodiments, the coil viewed in plan has, for example, a polygonal shape, in which case the polygonal shape is equated with a regular polygon such as a square shape with sides of equal length at the time when the proportion of the path in the first parallel section or the path in the second parallel section is calculated. In some embodiments, the coil viewed in plan has an elliptical or oval shape, in which case the elliptical or oval shape is equated with a circle at the time when the proportion of the path in the first parallel section or the path in the second parallel section is calculated.

For example, the proportion of the path in the first parallel section to the path corresponding to one turn of the coil is more than or equal to 0.4 and less than or equal to 0.8 (i.e., from 0.4 to 0.8), and the proportion of the path in the second parallel section to the path corresponding to one turn of the coil is more than or equal to 0.1 and less than 0.4 (i.e., from 0.1 to less than 0.4).

The number of parallel sections included in the coil of the multilayer coil component according to the present disclosure is not limited to a particular value. That is, the multilayer coil component according to the present disclosure may be configured in such a manner that the parallel section includes one or more parallel sections other than the first and second parallel sections.

For example, the parallel section may include, in addition to the first and second parallel sections, a third parallel section that is electrically connected in series with the second parallel section.

When the third parallel section is included in the parallel section, one of the coil conductors included in the second parallel section and one of the coil conductors included in the third parallel section are preferably connected directly to each other in one plane on a second insulating layer that is one of the insulating layers. That is, the first parallel section, the second parallel section, and the third parallel section each composed of coil conductors are preferably connected to each other with no other coil conductors interposed therebetween in the stacking direction. In this case, the first parallel section, the second parallel section, and the third parallel section may be connected to each other with lands therebetween.

When viewed in the stacking direction with the third parallel section being included in the parallel section, the coil conductors lying on top of each other with the second insulating layer therebetween at least partially overlap each other in a region other than the parallel section in which the coil conductors lying on top of each other with the second insulating layer therebetween are connected in parallel and overlap each other.

When one of the coil conductors included in the second parallel section and one of the coil conductors included in the third parallel section are connected directly to each other on the second insulating layer, the other coil conductor included in the second parallel section (a coil conductor being one of the coil conductors in the second parallel section and not disposed on the second insulating layer) and the other coil conductor included in the third parallel section (a coil conductor being one of the coil conductors in the third parallel section and not disposed on the second insulating layer) may be located on different insulating layers.

When one of the coil conductors included in the second parallel section and one of the coil conductors included in the third parallel section are connected directly to each other in one plane on the second insulating layer, the second parallel section and the third parallel section viewed in the stacking direction may be arranged with or without an overlap therebetween.

For example, the proportion of a path in the third parallel section to the path corresponding to one turn of the coil is more than or equal to 0.4 and less than or equal to 0.8 (i.e., from 0.4 to 0.8).

The parallel section may include, in addition to the first, second, and third parallel sections, a fourth parallel section that is electrically connected in series with the third parallel section.

When the third and fourth parallel sections are included in the parallel section, one of the coil conductors included in the third parallel section and one of the coil conductors included in the fourth parallel section are preferably connected directly to each other in one plane on a third insulating layer that is one of the insulating layers. That is, the first parallel section, the second parallel section, the third parallel section, and the fourth parallel section each composed of coil conductors are preferably connected to each other with no other coil conductors interposed therebetween in the stacking direction. In this case, the first parallel section, the second parallel section, the third parallel section, and the fourth parallel section may be connected to each other with lands therebetween.

When viewed in the stacking direction with the third and fourth parallel sections being included in the parallel section, the coil conductors lying on top of each other with the third insulating layer therebetween at least partially overlap each other in a region other than the parallel section in which the coil conductors lying on top of each other with the third insulating layer therebetween are connected in parallel and overlap each other.

When one of the coil conductors included in the third parallel section and one of the coil conductors included in the fourth parallel section are connected directly to each other on the third insulating layer, the other coil conductor included in the third parallel section (a coil conductor being one of the coil conductors in the third parallel section and not disposed on the third insulating layer) and the other coil conductor included in the fourth parallel section (a coil conductor being one of the coil conductors in the fourth parallel section and not disposed on the third insulating layer) may be disposed on different insulating layers.

When one of the coil conductors included in the third parallel section and one of the coil conductors included in the fourth parallel section are connected directly to each other in one plane on the third insulating layer, the third parallel section and the fourth parallel section viewed in the stacking direction may be arranged with or without an overlap therebetween.

For example, the proportion of a path in the fourth parallel section to the path corresponding to one turn of the coil is more than or equal to 0.1 and less than 0.4 (i.e., from 0.1 to less than 0.4).

With regard to the multilayer coil component according to the present embodiment, the geometry of each of the coil conductors viewed in plan is not limited to a particular shape. For example, the coil conductors each may be an L-shaped conductor including a bent portion or may be a square-cornered, U-shaped conductor including more than one bent portions when viewed in plan. Alternatively, the coil conductors may each be a U-shaped or C-shaped conductor including an arc-shaped portion when viewed in plan.

The coil conductors of the multilayer coil component according to the present disclosure each may have a segment that is not part of a bent portion and that is connected with at least one via conductor.

The embodiments described herein are merely examples. Needless to say, partial replacements or combinations of features illustrated in different embodiments are possible. Redundant description of features common to a first embodiment and another embodiment is omitted, and a second embodiment and subsequent embodiments are described with regard to their distinctive features only. This is particularly true for similar effects; that is, not every embodiment refers to such effects caused by similar configurations.

The accompanying drawings are schematic views and are not necessarily drawn to scale. For example, the aspect ratio of each element in the accompanying drawings is not necessarily in agreement with the aspect ratio of the corresponding element of a product for practical use.

### First Embodiment

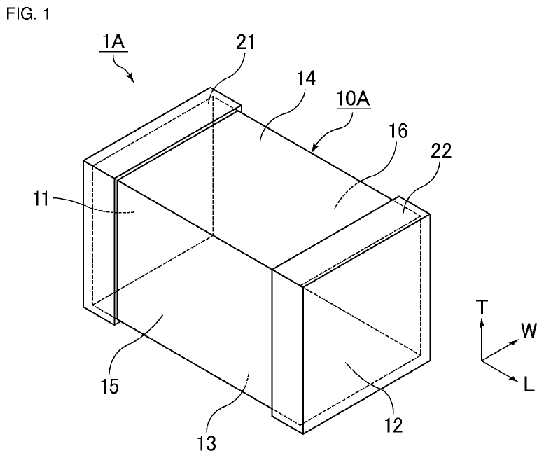

FIG. 1 is a schematic perspective view of an example of a multilayer coil component according to a first embodiment of the present disclosure.

Referring to FIG. 1, a multilayer coil component 1A includes a multilayer body 10A, an outer electrode 21, and an outer electrode 22. For example, the multilayer body 10A is a cuboid having six surfaces or is approximately cuboid in shape. The multilayer body 10A includes insulating layers and a coil, which are not illustrated in FIG. 1. The insulating layers are stacked on top of one another in a stacking direction. The coil is embedded in the multilayer body 10A. The outer electrodes 21 and 22 are each electrically connected to the coil.

The length direction, the height direction, and the width direction the multilayer coil component 1A and the multilayer body 10A are denoted by L, T, and W, respectively, in FIG. 1. The length direction L, the height direction T, and the width direction W are orthogonal to each other.

Referring to FIG. 1, the multilayer body 10A has a first end face 11, a second end face 12, a first main face 13, a second main face 14, a first side face 15, and a second side face 16. The first end face 11 and the second end face 12 are opposite to each other in the length direction L. The first main face 13 and the second main face 14 are opposite to each other in the height direction T. The first side face 15 and the second side face 16 are opposite to each other in the width direction W.

Unlike in FIG. 1, corners and ridges of the multilayer body 10A are preferably rounded. Each corner of the multilayer body 10A is a place where three faces of the multilayer body 10A meet. Each ridge of the multilayer body 10A is a place where two faces of the multilayer body 10A meet.

One of the outer electrodes 21 and 22 or, more specifically, the outer electrode 21 in an example illustrated in FIG. 1 covers the entirety of the first end face 11 of the multilayer body 10A and extends from the first end face 11 to cover part of the first main face 13, part of the second main face 14, part of the first side face 15, and part of the second side face 16.

One of the outer electrodes 21 and 22 or, more specifically, the outer electrode 22 in an example illustrated in FIG. 1 covers the entirety of the second end face 12 of the multilayer body 10A and extends from the second end face 12 to cover part of the first main face 13, part of the second main face 14, part of the first side face 15, and part of the second side face 16.

The multilayer coil component 1A having the outer electrodes 21 and 22 disposed thereon is to be mounted on a substrate, where one of the first main face 13, the second main face 14, the first side face 15, and the second side face 16 of the multilayer body 10A is a mounting surface.

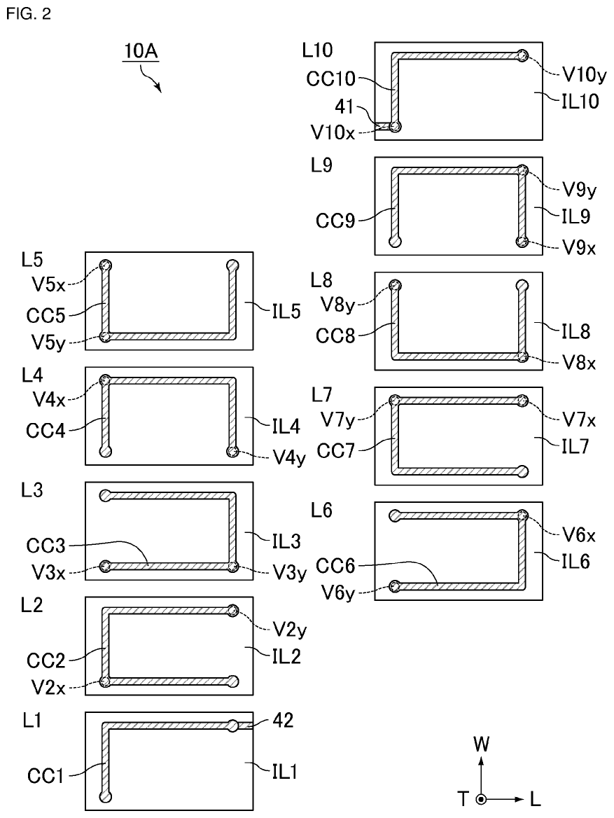

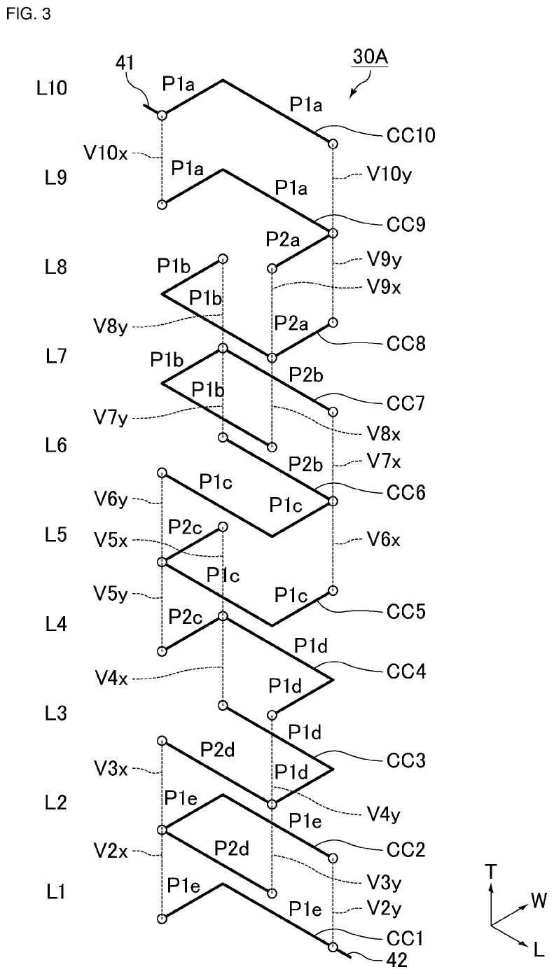

FIG. 2 is a schematic plan view of an example of the multilayer body included in the multilayer coil component according to the first embodiment of the present disclosure. FIG. 3 is an exploded perspective view of a coil embedded in the multilayer body in FIG. 2.

The multilayer body 10A illustrated in FIG. 2 includes a coil 30A, which is illustrated in FIG. 3 and embedded in the multilayer body 10A.

As illustrated in FIG. 2, the multilayer body 10A includes insulating layers respectively denoted by IL1, IL2, IL3, IL4, IL5, IL6, IL7, IL8, IL9, and IL10 and stacked in the height direction T from the first main face 13 (see FIG. 1) toward the second main face 14 (see FIG. 1) of the multilayer body 10A. The insulating layers IL1, IL2, IL3, IL4, IL5, IL6, IL7, IL8, IL9, and IL10 are hereinafter also collectively referred to as insulating layers IL.

Referring to FIG. 2, the insulating layer IL1 is disposed on the lower side in the stacking direction (i.e., the height direction T in the present embodiment) and is thus closer to the first main face 13 than to the other faces of the multilayer body 10A, and the insulating layer IL10 is disposed on the upper side in the stacking direction and is thus closer to the second main face 14 than to the other faces of the multilayer body 10A. With each of the insulating layers IL having two main faces, one main face on the negative side in the height direction T (i.e., on the back side of the drawing plane of FIG. 2) is located on the lower side in the stacking direction, and the other main surface on the positive side in the height direction T (i.e., on the front side of the drawing plane of FIG. 2) is located on the upper side in the stacking direction.

Each of the insulating layers IL is made of, for example, a magnetic material, such as a ferrite material.

Referring to FIG. 2, the insulating layers IL1, IL2, IL3, IL4, IL5, IL6, IL7, IL8, IL9, and I10 are provided with coil conductors CC1, CC2, CC3, CC4, CC5, CC6, CC7, CC8, CC9, and CC10, each of which is disposed on the corresponding one of the insulating layers IL. The coil conductors CC1, CC2, CC3, CC4, CC5, CC6, CC7, CC8, CC9, and CC10 are hereinafter also collectively referred to as coil conductors CC.

Each of the coil conductors CC1, CC2, CC3, CC4, CC5, CC6, CC7, CC8, CC9, and CC10 is disposed on a main face of the corresponding one of the insulating layers IL1, IL2, IL3, IL4, IL5, IL6, IL7, IL8, IL9, and IL10 or, more specifically, on a main face on the positive side in the height direction T (i.e., on the front side of the drawing plane of FIG. 2).

The coil 30A illustrated in FIG. 3 is composed of the coil conductors CC stacked together with the insulating layers IL in the stacking direction (i.e., the height direction T in the present embodiment) and electrically connected to each other.

In the example illustrated in FIGS. 2 and 3, the length of each of the coil conductors CC except for the coil conductors CC1 and CC10 is three-fourths of one turn of the coil 30A. The length of each of the coil conductors CC1 and CC10 is one-half of one turn of the coil 30A.

The coil conductor CC10 on a tenth layer L10 is an L-shaped conductor. The insulating layer IL10 on the tenth layer L10 is provided with via conductors V10x and V10y, which are provided to the respective ends of the coil conductor CC10.

The coil conductor CC9 on a ninth layer L9 is a square-cornered, U-shaped conductor. The insulating layer IL9 on the ninth layer L9 is provided with via conductors V9x and V9y, which are provided to an end of the coil conductor CC9 and a bent portion of the coil conductor CC9, respectively.

The coil conductor CC8 on an eighth layer L8 is a square-cornered, U-shaped conductor. The insulating layer IL8 on the eighth layer L8 is provided with via conductor V8x and V8y, which are provided to a bent portion of the coil conductor CC8 and an end of the coil conductor CC8, respectively.

The coil conductor CC7 on a seventh layer L7 is a square-cornered, U-shaped conductor. The insulating layer IL7 on the seventh layer L7 is provided with via conductor V7x and V7y, which are provided to an end of the coil conductor CC7 and a bent portion of the coil conductor CC7, respectively.

The coil conductor CC6 on a sixth layer L6 is a square-cornered, U-shaped conductor. The insulating layer IL6 on the sixth layer L6 is provided with via conductor V6x and V6y, which are provided to a bent portion of the coil conductor CC6 and an end of the coil conductor CC6, respectively.

The coil conductor CC5 on a fifth layer L5 is a square-cornered, U-shaped conductor. The insulating layer IL5 on the fifth layer L5 is provided with via conductor V5x and V5y, which are provided to an end of the coil conductor CC5 and a bent portion of the coil conductor CC5, respectively.

The coil conductor CC4 on a fourth layer L4 is a square-cornered, U-shaped conductor. The insulating layer IL4 on the fourth layer L4 is provided with via conductor V4x and V4y, which are provided to a bent portion of the coil conductor CC4 and an end of the coil conductor CC4, respectively.

The coil conductor CC3 on a third layer L3 is a square-cornered, U-shaped conductor. The insulating layer IL3 on the third layer L3 is provided with via conductor V3x and V3y, which are provided to an end of the coil conductor CC3 and a bent portion of the coil conductor CC3, respectively.

The coil conductor CC2 on a second layer L2 is a square-cornered, U-shaped conductor. The insulating layer IL2 on the second layer L2 is provided with via conductor V2x and V2y, which are provided to a bent portion of the coil conductor CC2 and an end of the coil conductor CC2, respectively.

The coil conductor CC1 on a first layer L1 is an L-shaped conductor.

The via conductors V2x, V2y, V3x, V3y, V4x, V4y, V5x, V5y, V6x, V6y, V7x, V7y, V8x, V8y, V9x, V9y, V10x, and V10y are hereinafter also collectively referred to as via conductors V.

The via conductors V extend through the insulating layers IL in the stacking direction (i.e., the height direction T in the present embodiment).

The insulating layers IL preferably include, on main faces thereof, lands for connection with the via conductors V. It is preferred that the size of each land be slightly greater than the line width of each coil conductor CC, that is, than the width of each conductor part not including the lands.

For example, the coil conductors CC (inclusive of the lands) and the via conductors V are ach made of Ag, Au, Cu, Pd, Ni, Al, or an alloy containing at least one of these metals.

The insulating layers IL illustrated in FIG. 2 are stacked on top of one another in the height direction T such that the via conductors V each form an electrical connection between the coil conductors CC. Accordingly, the coil 30A in the multilayer body 10A is in the form of a solenoid having a coil axis extending in the height direction T, as illustrated in FIG. 3.

Referring to FIG. 2, an end portion of the coil conductor CC10 on the tenth layer L10 is connected with an extended conductor 41, which is exposed at the first end face 11 (see FIG. 1) of the multilayer body 10A. The extended conductor 41 in the multilayer body 10A forms a connection between the outer electrode 21 (see FIG. 1) and the coil conductor CC10.

Likewise, an end portion of the coil conductor CC1 on the first layer L1 is connected with an extended conductor 42, which is exposed at the second end face 12 (see FIG. 1) of the multilayer body 10A. The extended conductor 42 in the multilayer body 10A forms a connection between the outer electrode 22 (see FIG. 1) and the coil conductor CC1.

The multilayer body 10A preferably includes one or more insulating layers IL (not illustrated in FIG. 2) closer to the second main face 14 than to the other main face and not provided with the coil conductors CC. In this case, the extended conductor 41 may be exposed at the second main face 14 of the multilayer body 10A. That is, the surface of the multilayer body 10A at which the extended conductor 41 is exposed is not necessarily the first end face 11 of the multilayer body 10A. Likewise, the multilayer body 10A preferably includes one or more insulating layers IL closer to the first main face 13 than to the other main face and not provided with the coil conductors CC. In this case, the extended conductor 42 may be exposed at the first main face 13 of the multilayer body 10A. That is, the surface of the multilayer body 10A at which the extended conductor 42 is exposed is not necessarily the second end face 12 of the multilayer body 10A. The same holds true for the following embodiments.

When viewed in the height direction T, the coil 30A may have a shape (e.g., a polygonal shape) made up of linear portions as illustrated in FIGS. 2 and 3, a shape (e.g., a circular shape or an elliptical shape) made up of curved portions, or a shape made up of a linear portion and a curved portion.

Referring to FIGS. 2 and 3, the stacking direction of the insulating layers IL and the coil axis of the coil 30A are orthogonal to the mounting surface (e.g., the first main face 13) of the multilayer body 10A. Alternatively, the stacking direction of the insulating layers IL and the coil axis of the coil 30A may be parallel to the mounting surface (e.g., the first main face 13) of the multilayer body 10A.

The coil 30A includes a parallel section composed of two coil conductors CC that are stacked in layers and electrically connected in parallel by the via conductors V interposed therebetween. The parallel section includes a first parallel section and a second parallel section that is electrically connected in series with the first parallel section. The number of parallel sections included in the coil 30A is not limited to a particular value.

Referring to FIG. 3, a parallel section P1e, a parallel section P2d, a parallel section P1d, a parallel section P2c, a parallel section P1c, a parallel section P2b, a parallel section P1b, a parallel section P2a, and a parallel section P1a are arranged in sequence from the negative side toward the positive side in the height direction T. For example, the parallel section P1a is the first parallel section, and the parallel section P2a is the second parallel section. It is not required that the first parallel section be the parallel section P1a. The first parallel section be any one of the parallel sections P1a, P1b, P1c, and P1d.

The parallel section P1a is the region where the coil conductor CC10 on the tenth layer L10 and part of the coil conductor CC9 on the ninth layer L9 are electrically connected in parallel by the via conductors V10x and V10y interposed therebetween.

The parallel section P2a is the region where part of the coil conductor CC9 on the ninth layer L9 and part of the coil conductor CC8 on the eighth layer L8 are electrically connected in parallel by the via conductors V9x and V9y interposed therebetween.

The parallel section P1b is the region where part of the coil conductor CC8 on the eighth layer L8 and part of the coil conductor CC7 on the seventh layer L7 are electrically connected in parallel by the via conductors V8x and V8y interposed therebetween.

The parallel section P2b is the region where part of the coil conductor CC7 on the seventh layer L7 and part of the coil conductor CC6 on the sixth layer L6 are electrically connected in parallel by the via conductors V7x and V7y interposed therebetween.

The parallel section Plc is the region where part of the coil conductor CC6 on the sixth layer L6 and part of the coil conductor CC5 on the fifth layer L5 are electrically connected in parallel by the via conductors V6x and V6y interposed therebetween.

The parallel section P2c is the region where part of the coil conductor CC5 on the fifth layer L5 and part of the coil conductor CC4 on the fourth layer L4 are electrically connected in parallel by the via conductors V5x and V5y interposed therebetween.

The parallel section P1d is the region where part of the coil conductor CC4 on the fourth layer L4 and part of the coil conductor CC3 on the third layer L3 are electrically connected in parallel by the via conductors V4x and V4y interposed therebetween.

The parallel section P2d is the region where part of the coil conductor CC3 on the third layer L3 and part of the coil conductor CC2 on the second layer L2 are electrically connected in parallel by the via conductors V3x and V3y interposed therebetween.

The parallel section P1e is the region where part of the coil conductor CC2 on the second layer L2 and the coil conductor CC1 on the first layer L1 are electrically connected in parallel by the via conductors V2x and V2y interposed therebetween.

As illustrated in FIGS. 2 and 3, one of the coil conductors CC included in the first parallel section and one of the coil conductors CC included in the second parallel section are connected directly to each other in one plane on a first insulating layer that is one of the insulating layers IL.

For example, the insulating layer IL9 on the ninth layer L9 is the first insulating layer, provided that the parallel section P1a and the parallel section P2a are the first parallel section and the second parallel section, respectively. A portion being part of the coil conductor CC9 and included in the parallel section P1a and a portion being part of the coil conductor CC9 and included in the parallel section P2a are connected directly to each other in one plane on the insulating layer IL9 in the ninth layer L9.

When viewed in the stacking direction (i.e., the height direction T in the present embodiment), the coil conductors CC lying on top of each other with the first insulating layer therebetween at least partially overlap each other in a region other than the parallel section in which the coil conductors CC lying on top of each other with the first insulating layer therebetween are connected in parallel and overlap each other.

For example, the parallel section P1a is the first parallel section, and the parallel section P2a is the second parallel section. When the coil conductors CC9 and CC8 lying on top of each other with the first insulating layer, namely, the insulating layer IL9 on the ninth layer L9 therebetween are viewed in the height direction T, a portion being part of the coil conductor CC9 and included in the parallel section P1a and a portion being part of the coil conductor CC8 and included in the parallel section P1b overlap each other in a region other than the parallel section P2a in which the coil conductors CC9 and CC8 lying on top of each other with the insulating layer IL9 therebetween are connected in parallel and overlap each other.

The parallel section of the coil 30A may include, in addition to the first and second parallel sections, a third parallel section that is electrically connected in series with the second parallel section. For example, the parallel section P1b is the third parallel section, provided that the parallel section P1a and the parallel section P2a are the first parallel section and the second parallel section, respectively.

As illustrated in FIGS. 2 and 3, one of the coil conductors CC included in the second parallel section and one of the coil conductors CC included in the third parallel section are preferably connected directly to each other in one plane on a second insulating layer that is one of the insulating layers IL.

For example, the insulating layer IL8 on the eighth layer L8 is the second insulating layer, provided that the parallel section P1a, the parallel section P2a, and the parallel section P1b are the first parallel section, the second parallel section, and the third parallel section, respectively. A portion being part of the coil conductor CC8 and included in the parallel section P2a and a portion being part of the coil conductor CC8 and included in the parallel section P1b are connected directly to each other in one plane on the insulating layer IL8 in the eighth layer L8.

The parallel section of the coil 30A may include, in addition to the first, second, and third parallel sections, a fourth parallel section that is electrically connected in series with the third parallel section. For example, the parallel section P2b is the fourth parallel section, provided that the parallel section P1a, the parallel section P2a, and the parallel section P1b are the first parallel section, the second parallel section, and the third parallel section, respectively.

As illustrated in FIGS. 2 and 3, one of the coil conductors CC included in the third parallel section and one of the coil conductors CC included in the fourth parallel section are preferably connected directly to each other in one plane on a third insulating layer that is one of the insulating layers IL.

For example, the insulating layer IL7 on the seventh layer L7 is the third insulating layer, provided that the parallel section P1a, the parallel section P2a, the parallel section P1b, and the parallel section P2b are the first parallel section, the second parallel section, the third parallel section, and the fourth parallel section, respectively. A portion being part of the coil conductor CC7 and included in the parallel section P1b and a portion being part of the coil conductor CC7 included in the parallel section P2b are connected directly to each other in one plane on the insulating layer IL7 in the seventh layer L7.

Referring to FIG. 3, the proportion of a path in the first parallel section to the path corresponding to one turn of the coil 30A is not equal to the proportion of a path in the second parallel section to the path corresponding to one turn of the coil 30A.

As described below, the rectangular shape of the coil 30A viewed in plan is equated with a square shape at the time when the proportion of the path in each parallel section is calculated.

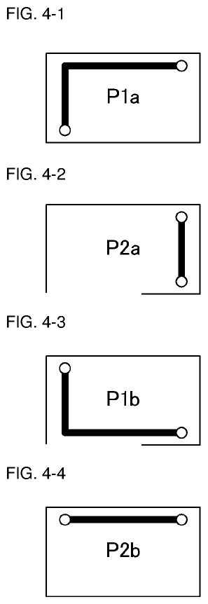

FIG. 4-1 is a schematic plan view of a path in the parallel section P1a of the coil 30A in FIG. 3.

The parallel section P1a has an L-shape including a short side and a long side of the rectangular shape. The length of the parallel section P1a is one-half of the length of one turn of the coil 30A. That is, the proportion of the path in the parallel section P1a to the path corresponding to one turn of the coil 30A is ½ (0.5).

FIG. 4-2 is a schematic plan view of a path in the parallel section P2a of the coil 30A in FIG. 3.

The parallel section P2a is in the form of a straight line including a short side of the rectangular shape. The length of the parallel section P2a is one-fourth of the length of one turn of the coil 30A. That is, the proportion of the path in the parallel section P2a to the path corresponding to one turn of the coil 30A is ¼ (0.25).

FIG. 4-3 is a schematic plan view of a path in the parallel section P1b of the coil 30A in FIG. 3.

The parallel section P1b has an L-shape including a long side and a short side of the rectangular shape. The length of the parallel section P1b is one-half of the length of one turn of the coil 30A. That is, the proportion of the path in the parallel section P1b to the path corresponding to one turn of the coil 30A is ½ (0.5).

FIG. 4-4 is a schematic plan view of a path in the parallel section P2b of the coil 30A in FIG. 3.

The parallel section P2b is in the form of a straight line including a long side of the rectangular shape. The length of the parallel section P2b is one-fourth of the length of one turn of the coil 30A. That is, the proportion of the path in the parallel section P2b to the path corresponding to one turn of the coil 30A is ¼ (0.25).

The same goes for the parallel section P1c, the parallel section P2c, the parallel section P1d, the parallel section P2d, and the parallel section P1e.

Referring to FIGS. 2 and 3, the proportion of the path in the first parallel section to the path corresponding to one turn of the coil 30A is not equal to the proportion of the path in the second parallel section to the path corresponding to one turn of the coil 30A (½ ≠¼) when the parallel section P1a and the parallel section P2a are the first parallel section and the second parallel section, respectively.

Referring to FIGS. 2 and 3, the proportion of the path in the first parallel section to the path corresponding to one turn of the coil 30A is equal to the proportion of the path in the third parallel section to the path corresponding to one turn of the coil 30A (½=½), and the proportion of the path in the second parallel section to the path corresponding to one turn of the coil 30A is equal to the proportion of the path in the fourth parallel section to the path corresponding to one turn of the coil 30A (¼=¼) when the parallel section P1a, the parallel section P2a, the parallel section P1b, and the parallel section P2b are the first parallel section, the second parallel section, the third parallel section, and the fourth parallel section, respectively.

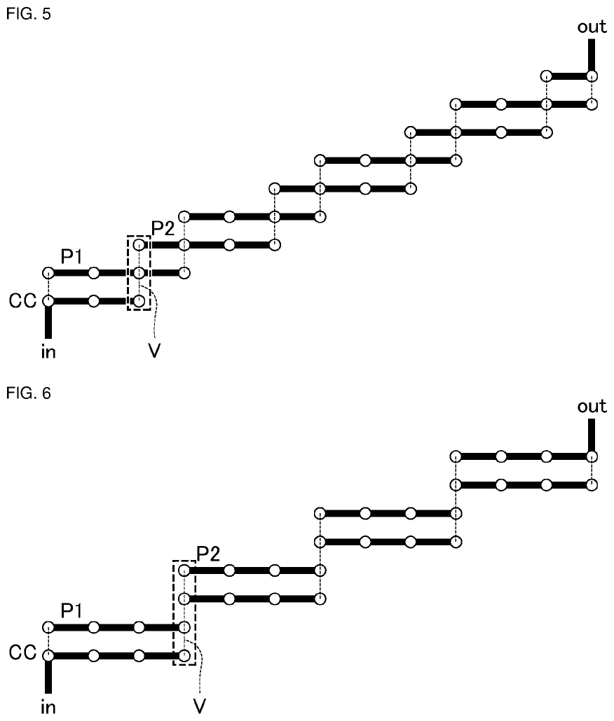

FIG. 5 is a schematic development view of an example of the coil included in the multilayer coil component according to the first embodiment of the present disclosure.

Referring to FIG. 5, a first parallel section P1 and a second parallel section P2 are each composed of two coil conductors, and one of the coil conductors CC included in the first parallel section P1 and one of the coil conductors CC included in the second parallel section P2 are located on the same insulating layer (not illustrated), in which case a maximum of two via conductors V are disposed on top of each other with no other via conductors interposed therebetween in the stacking direction.

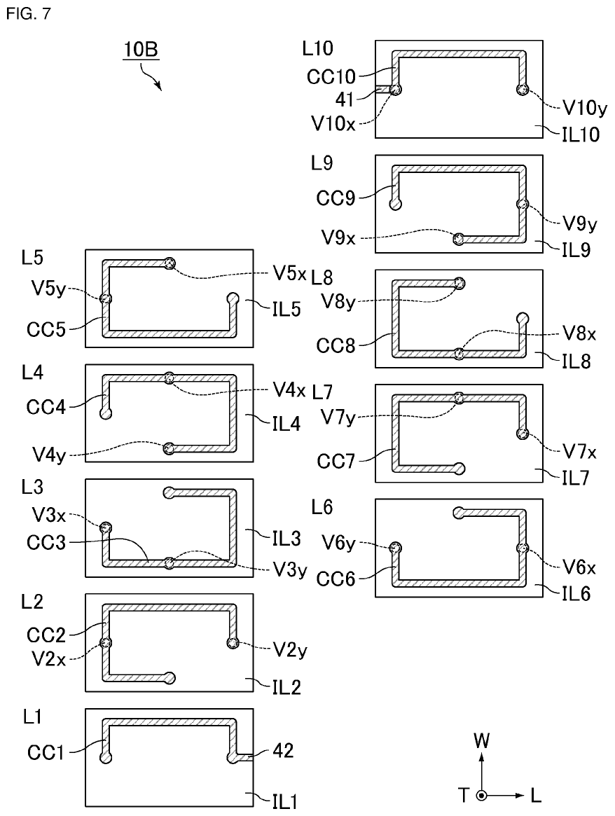

FIG. 6 is a schematic development view of an example of a coil included in a conventional multilayer coil component.

Referring to FIG. 6, a first parallel section P1 and a second parallel section P2 are each composed of two coil conductors, and every part of each coil conductor CC included in the first parallel section P1 and every part of each coil conductor CC included in the second parallel section P2 are not located on the same insulating layer (not illustrated), in which case a maximum of three via conductors V are disposed on top of each other with no other via conductors interposed therebetween in the stacking direction.

As can be understood from a comparison of FIG. 5 to FIG. 6, the number of via conductors V disposed on top of each other in the stacking direction can be reduced by the present embodiment, in which one of the coil conductors CC included in the first parallel section P1 and one of the coil conductors CC included in the second parallel section P2 are located on the same insulating layer.

The following describes an example method for producing the multilayer coil component 1A in FIG. 1.

<Step of Preparing Magnetic Material>

First, Fe₂O₃, ZnO, CuO, and NiO are weighed out to a predetermined ratio.

The weighed materials and pure water or the like are mixed with partially stabilized zirconia (PSZ) media in a ball mill. The mixture is then pulverized. The mixing and pulverization time is, for example, more than or equal to four hours and less than or equal to eight hours (i.e., from four hours to eight hours).

The pulverized mixture is dried and is then calcined. The calcination temperature is, for example, higher than or equal to 700° C. and lower than or equal to 800° C. (i.e., from 700° C. to 800° C.). The calcination time is, for example, more than or equal to two hours and less than or equal to five hours.

In this way, a magnetic material in powder form or, more specifically, a magnetic ferrite material in powder form is prepared.

The ferrite material is preferably an Ni—Cu—Zn ferrite material.

The Ni—Cu—Zn ferrite material preferably has an Fe content of 40 mol % or more and 49.5 mol % or less (i.e., from 40 mol % to 49.5 mol %) in terms of Fe₂O₃, a Zn content of 2 mol % or more and 35 mol % or less (i.e., from 2 mol % to 35 mol %) in terms of ZnO, a Cu content of 6 mol % or more and 13 mol % or less (i.e., from 6 mol % to 13 mol %) in terms of CuO, and an Ni content of 10 mol % or more and 45 mol % or less (i.e., from 10 mol % to 45 mol %) in terms of NiO, provided that the total amount of the Ni—Cu—Zn ferrite material is 100 mol %.

The Ni—Cu—Zn ferrite material may contain additive elements, such as Co, Bi, Sn, and Mn.

The Ni—Cu—Zn ferrite material may also contain inevitable impurities.

Step of Preparing Green Sheet

The magnetic material and the PSZ media are mixed with an organic binder (e.g., polyvinyl butyral resin), an organic solvent (e.g., ethanol and toluene), and a plasticizer in a ball mill. The mixture is then pulverized to prepare slurry.

The slurry is formed into a sheet of a predetermined thickness by using, for example, the doctor blade technique. The sheet is then stamped into a predetermined shape, thus being formed into a green sheet. The thickness of the green sheet is, for example, more than or equal to 20 m and less than or equal to 30 m (i.e., from 20 m to 30 km). The green sheet is, for example, rectangular in shape.

Instead of being made of the magnetic material, the green sheet may be made of a non-magnetic material (e.g., a borosilicate glass material) or a mixture of a magnetic material and a non-magnetic material.

Step of Forming Conductor Patterns

First, laser beams are applied to predetermined points on the green sheet to form via holes.

A conductive paste (e.g., an Ag paste) is then applied to a surface of the green sheet by, for example, screen printing in such a manner that the via holes are filled with the conductive paste. In this way, conductor patterns for via conductors are formed in the via holes of the green sheet, and conductor patterns for coil conductors are formed on the surface of the green sheet in a manner so as to be connected to the conductor patterns for via conductors. Coil sheets with the conductor patterns for coil conductors and the conductor patterns for via conductors are obtained from the green sheet accordingly. The coil sheets are provided with the conductor patterns for the coil conductors CC (inclusive of the extended conductors 41 and 42) illustrated in FIGS. 2 and 3 and the conductor patterns for the via conductors V illustrated in FIGS. 2 and 3.

Step of Preparing Multilayer Block

The coil sheets are arranged in the order illustrated in FIGS. 2 and 3 (i.e., in sequence from the negative side toward the positive side in the height direction T in the present embodiment) to form a stack, which is then formed into a multilayer block by thermocompression bonding.

Step of Preparing Multilayer Body and Coil

First, the multilayer block is cut into chips of a predetermined size by, for example, a dicing machine.

The individual chips are then fired. The firing temperature is, for example, higher than or equal to 900° C. and lower than or equal to 920° C. (i.e., from 900° C. to 920° C.). The firing time is, for example, more than or equal to two hours and less than or equal to four hours (i.e., from two hours to four hours).

The individual chips are fired such that the green sheets or, more specifically, the coil sheets are formed into insulating layers.

The conductor patterns for coil conductors in the fired individual chips are formed into coil conductors, and the conductor patterns for via conductors in the fired individual chips are formed into via conductors. Accordingly, a coil composed of the coil conductors stacked together with the insulating layers and electrically connected to each other by the via conductors is prepared.

A multilayer body obtained by following the procedure described above includes the insulating layers and the coil. The insulating layers are stacked on top of one another in the stacking direction, and the coil embedded in the multilayer body.

In addition, corners and ridges of the multilayer body may rounded by, for example, barrel polishing.

Step of Forming Outer Electrodes

First, a conductive paste, such as a paste containing Ag and glass frit, is applied to the multilayer body to form conductive paste layers. The conductive paste is applied to an outer surface of the multilayer body or, more specifically, end faces to which the coil is extended.

The conductive paste layers are then baked to form underlying electrodes for outer electrodes. The baking temperature is, for example, higher than or equal to 800° C. and lower than or equal to 820° C. (i.e., from 800° C. to 820° C.). The thickness of each of the underlying electrodes is, for example, 5 m.

Then, an Ni plating electrode and an Sn plating electrode are sequentially formed on the surface of each of the underlying electrodes by, for example, electrolytic plating. Accordingly, outer electrodes each including an underlying electrode, an Ni plating electrode on the underlying electrode, and an Sn plating electrode on the Ni plating electrode are formed.

In this way, the multilayer coil component 1A is produced.

For example, the dimensions of the multilayer coil component 1A are as follows: length (dimension in the length direction L)=2.0 mm, width (dimension in the width direction W)=1.25 mm, and height (dimension in the height direction T)=1.25 mm.

### Second Embodiment

Coil conductors of a multilayer coil component according to a second embodiment of the present disclosure each have a segment that is not part of a bent portion and that is connected with at least one via conductor.

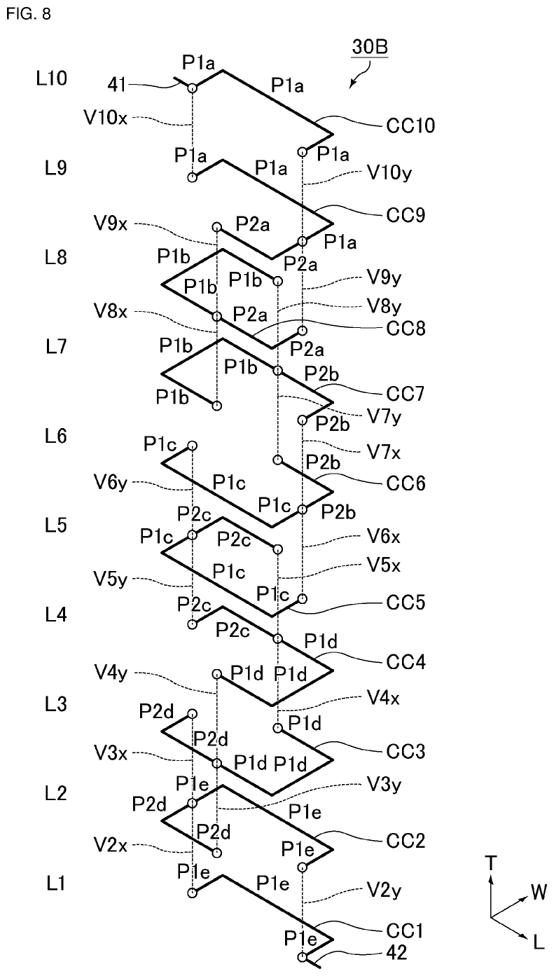

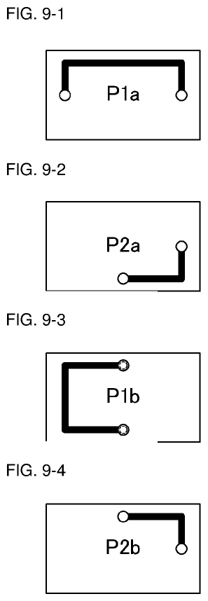

FIG. 7 is a schematic plan view of an example of a multilayer body included in the multilayer coil component according to the second embodiment of the present disclosure. FIG. 8 is an exploded perspective view of a coil embedded in the multilayer body in FIG. 7.

A multilayer body 10B is illustrated in FIG. 7 and includes a coil 30B, which is illustrated in FIG. 8 and embedded in the multilayer body 10B.

As with the multilayer body 10A illustrated in FIG. 2, the multilayer body 10B illustrated in FIG. 7 includes insulating layers stacked in the height direction T from its first main face toward its second main face. The insulating layers included in the multilayer body 10B are denoted by IL1, IL2, IL3, IL4, IL5, IL6, IL7, IL8, IL9, and IL10, respectively. The insulating layers IL1, IL2, IL3, IL4, IL5, IL6, IL7, IL8, IL9, and IL10 are hereinafter also collectively referred to as insulating layers IL.

Referring to FIG. 7, the insulating layers IL1, IL2, IL3, IL4, IL5, IL6, IL7, IL8, IL9, and IL10 are provided with coil conductors CC1, CC2, CC3, CC4, CC5, CC6, CC7, CC8, CC9, and CC10, each of which is disposed on the corresponding one of the insulating layers IL. The coil conductors CC1, CC2, CC3, CC4, CC5, CC6, CC7, CC8, CC9, and CC10 are hereinafter also collectively referred to as coil conductors CC.

The coil 30B illustrated in FIG. 8 is composed of the coil conductors CC stacked together with the insulating layers IL in the stacking direction (i.e., the height direction T in the present embodiment) and electrically connected to each other.

In the example illustrated in FIGS. 7 and 8, the length of each of the coil conductors CC except for the coil conductors CC1 and CC10 is three-fourths of one turn of the coil 30B. The length of each of the coil conductors CC1 and CC10 is one-half of one turn of the coil 30B.

The insulating layer IL10 on a tenth layer L10 is provided with via conductors V10x and V10y, which are provided to the respective ends of the coil conductor CC10.

The insulating layer IL9 on a ninth layer L9 is provided with via conductors V9x and V9y, which are provided to an end of the coil conductor CC9 and a segment of the coil conductor CC9, respectively.

The insulating layer IL8 on an eighth layer L8 is provided with via conductor V8x and V8y, which are provided to a segment of the coil conductor CC8 and an end of the coil conductor CC8, respectively.

The insulating layer IL7 on a seventh layer L7 is provided with via conductor V7x and V7y, which are provided to an end of the coil conductor CC7 and a segment of the coil conductor CC7, respectively.

The insulating layer IL6 on a sixth layer L6 is provided with via conductor V6x and V6y, which are provided to a segment of the coil conductor CC6 and an end of the coil conductor CC6, respectively.

The insulating layer IL5 on a fifth layer L5 is provided with via conductor V5x and V5y, which are provided to an end of the coil conductor CC5 and a segment of the coil conductor CC5, respectively.

The insulating layer IL4 on a fourth layer L4 is provided with via conductor V4x and V4y, which are provided to a segment of the coil conductor CC4 and an end of the coil conductor CC4, respectively.

The insulating layer IL3 on a third layer L3 is provided with via conductor V3x and V3y, which are provided to an end of the coil conductor CC3 and a segment of the coil conductor CC3, respectively.

The insulating layer IL2 on a second layer L2 is provided with via conductor V2x and V2y, which are provided to a segment of the coil conductor CC2 and an end of the coil conductor CC2, respectively.

The via conductors V2x, V2y, V3x, V3y, V4x, V4y, V5x, V5y, V6x, V6y, V7x, V7y, V8x, V8y, V9x, V9y, V10x, and V10y are hereinafter also collectively referred to as via conductors V.

The insulating layers IL illustrated in FIG. 7 are stacked on top of one another in the height direction T such that the via conductors V each form an electrical connection between the coil conductors CC. Accordingly, the coil 30B in the multilayer body 10B is in the form of a solenoid having a coil axis extending in the height direction T, as illustrated in FIG. 8.

Referring to FIG. 7, an end portion of the coil conductor CC10 on the tenth layer L10 is connected with an extended conductor 41, which is exposed at the first end face of the multilayer body 10B. The extended conductor 41 in the multilayer body 10B forms a connection between one of two outer electrodes and the coil conductor CC10.

Likewise, an end portion of the coil conductor CC1 on a first layer L1 is connected with an extended conductor 42, which is exposed at the second end face of the multilayer body 10B. The extended conductor 42 in the multilayer body 10B forms a connection between the other outer electrode and the coil conductor CC1.

The coil 30B includes a parallel section composed of two coil conductors CC that are stacked in layers and electrically connected in parallel by the via conductors V interposed therebetween. The parallel section includes a first parallel section and a second parallel section that is electrically connected in series with the first parallel section. The number of parallel sections included in the coil 30B is not limited to a particular value.

Referring to FIG. 8, a parallel section P1e, a parallel section P2d, a parallel section P1d, a parallel section P2c, a parallel section P1c, a parallel section P2b, a parallel section P1b, a parallel section P2a, and a parallel section P1a are arranged in sequence from the negative side toward the positive side in the height direction T. For example, the parallel section P1a is the first parallel section, and the parallel section P2a is the second parallel section. It is not required that the first parallel section be the parallel section P1a. The first parallel section be any one of the parallel sections P1a, P1b, P1c, and P1d.

The parallel section P1a is the region where the coil conductor CC10 on the tenth layer L10 and part of the coil conductor CC9 on the ninth layer L9 are electrically connected in parallel by the via conductors V10x and V10y interposed therebetween.

The parallel section P2a is the region where part of the coil conductor CC9 on the ninth layer L9 and part of the coil conductor CC8 on the eighth layer L8 are electrically connected in parallel by the via conductors V9x and V9y interposed therebetween.

The parallel section P1b is the region where part of the coil conductor CC8 on the eighth layer L8 and part of the coil conductor CC7 on the seventh layer L7 are electrically connected in parallel by the via conductors V8x and V8y interposed therebetween.

The parallel section P2b is the region where part of the coil conductor CC7 on the seventh layer L7 and part of the coil conductor CC6 on the sixth layer L6 are electrically connected in parallel by the via conductors V7x and V7y interposed therebetween.

The parallel section Plc is the region where part of the coil conductor CC6 on the sixth layer L6 and part of the coil conductor CC5 on the fifth layer L5 are electrically connected in parallel by the via conductors V6x and V6y interposed therebetween.

The parallel section P2c is the region where part of the coil conductor CC5 on the fifth layer L5 and part of the coil conductor CC4 on the fourth layer L4 are electrically connected in parallel by the via conductors V5x and V5y interposed therebetween.

The parallel section P1d is the region where part of the coil conductor CC4 on the fourth layer L4 and part of the coil conductor CC3 on the third layer L3 are electrically connected in parallel by the via conductors V4x and V4y interposed therebetween.

The parallel section P2d is the region where part of the coil conductor CC3 on the third layer L3 and part of the coil conductor CC2 on the second layer L2 are electrically connected in parallel by the via conductors V3x and V3y interposed therebetween.

The parallel section P1e is the region where part of the coil conductor CC2 on the second layer L2 and the coil conductor CC1 on the first layer L1 are electrically connected in parallel by the via conductors V2x and V2y interposed therebetween.

As illustrated in FIGS. 7 and 8, one of the coil conductors CC included in the first parallel section and one of the coil conductors CC included in the second parallel section are connected directly to each other in one plane on a first insulating layer that is one of the insulating layers IL.

For example, the insulating layer IL9 on the ninth layer L9 is the first insulating layer, provided that the parallel section P1a and the parallel section P2a are the first parallel section and the second parallel section, respectively. A portion being part of the coil conductor CC9 and included in the parallel section P1a and a portion being part of the coil conductor CC9 and included in the parallel section P2a are connected directly to each other in one plane on the insulating layer IL9 in the ninth layer L9.

When viewed in the stacking direction (i.e., the height direction T in the present embodiment), the coil conductors CC lying on top of each other with the first insulating layer therebetween at least partially overlap each other in a region other than the parallel section in which the coil conductors CC lying on top of each other with the first insulating layer therebetween are connected in parallel and overlap each other.

For example, the parallel section P1a is the first parallel section, and the parallel section P2a is the second parallel section. When the coil conductors CC9 and CC8 lying on top of each other with the first insulating layer, namely, the insulating layer IL9 on the ninth layer L9 therebetween are viewed in the height direction T, a portion being part of the coil conductor CC9 and included in the parallel section P1a and a portion being part of the coil conductor CC8 and included in the parallel section P1b overlap each other in a region other than the parallel section P2a in which the coil conductors CC9 and CC8 lying on top of each other with the insulating layer IL9 therebetween are connected in parallel and overlap each other.

The parallel section of the coil 30B may include, in addition to the first and second parallel sections, a third parallel section that is electrically connected in series with the second parallel section. For example, the parallel section P1b is the third parallel section, provided that the parallel section P1a and the parallel section P2a are the first parallel section and the second parallel section, respectively.

As illustrated in FIGS. 7 and 8, one of the coil conductors CC included in the second parallel section and one of the coil conductors CC included in the third parallel section are preferably connected directly to each other in one plane on a second insulating layer that is one of the insulating layers IL.

For example, the insulating layer IL8 on the eighth layer L8 is the second insulating layer, provided that the parallel section P1a, the parallel section P2a, and the parallel section P1b are the first parallel section, the second parallel section, and the third parallel section, respectively. A portion being part of the coil conductor CC8 and included in the parallel section P2a and a portion being part of the coil conductor CC8 and included in the parallel section P1b are connected directly to each other in one plane on the insulating layer IL8 in the eighth layer L8.

The parallel section of the coil 30B may include, in addition to the first, second, and third parallel sections, a fourth parallel section that is electrically connected in series with the third parallel section. For example, the parallel section P2b is the fourth parallel section, provided that the parallel section P1a, the parallel section P2a, and the parallel section P1b are the first parallel section, the second parallel section, and the third parallel section, respectively.

As illustrated in FIGS. 7 and 8, one of the coil conductors CC included in the third parallel section and one of the coil conductors CC included in the fourth parallel section are preferably connected directly to each other in one plane on a third insulating layer that is one of the insulating layers IL.

For example, the insulating layer IL7 on the seventh layer L7 is the third insulating layer, provided that the parallel section P1a, the parallel section P2a, the parallel section P1b, and the parallel section P2b are the first parallel section, the second parallel section, the third parallel section, and the fourth parallel section, respectively. A portion being part of the coil conductor CC7 and included in the parallel section P1b and a portion being part of the coil conductor CC7 and included in the parallel section P2b are connected directly to each other in one plane on the insulating layer IL7 in the seventh layer L7.

Referring to FIG. 8, the proportion of a path in the first parallel section to the path corresponding to one turn of the coil 30B is not equal to the proportion of a path in the second parallel section to the path corresponding to one turn of the coil 30B.

As described below, the rectangular shape of the coil 30B viewed in plan is equated with a square at the time when the proportion of the path in each parallel section is calculated.

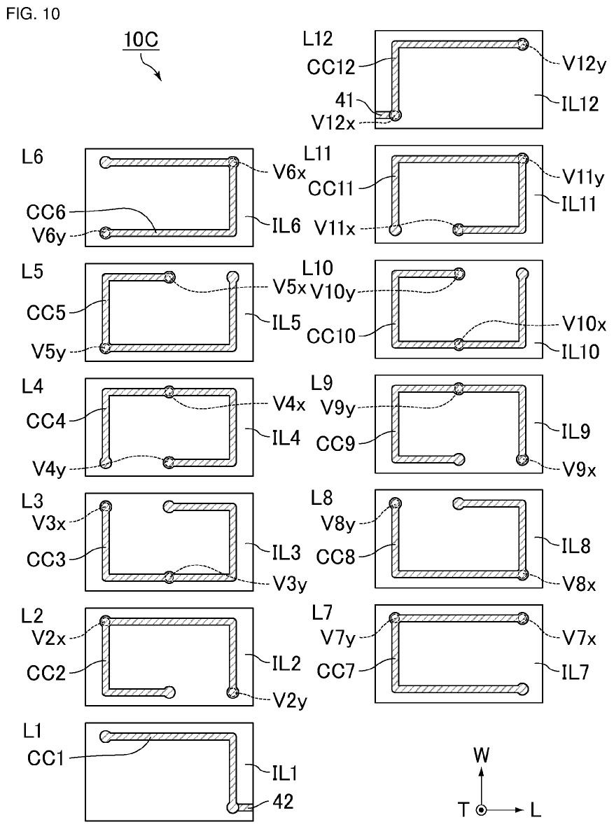

FIG. 9-1 is a schematic plan view of a path in a parallel section P1a of the coil 30B in FIG. 8.

The parallel section P1a has a square-cornered U-shape including one-half of one of two short sides of the rectangular shape, a long side of the rectangular shape, and one-half of the other short side of the rectangular shape. The length of the parallel section P1a is one-half of the length of one turn of the coil 30B. That is, the proportion of the path in the parallel section P1a to the path corresponding to one turn of the coil 30B is ½ (0.5).

FIG. 9-2 is a schematic plan view of a path in the parallel section P2a of the coil 30B in FIG. 8.

The parallel section P2a has an L-shape including one-half of a short side of the rectangular shape and one-half of a long side of the rectangular shape. The length of the parallel section P2a is one-fourth of the length of one turn of the coil 30B. That is, the proportion of the path in the parallel section P2a to the path corresponding to one turn of the coil 30B is ¼ (0.25).

FIG. 9-3 is a schematic plan view of a path in the parallel section P1b of the coil 30B in FIG. 8.

The parallel section P1b has a square-cornered U-shape including one-half of one of two long sides of the rectangular shape, a short side of the rectangular shape, and one-half of the other long side of the rectangular shape. The length of the parallel section P1b is one-half of the length of one turn of the coil 30B. That is, the proportion of the path in the parallel section P1b to the path corresponding to one turn of the coil 30B is ½ (0.5).

FIG. 9-4 is a schematic plan view of a path in the parallel section P2b of the coil 30B in FIG. 8.

The parallel section P2b has an L-shape including one-half of a long side of the rectangular shape and one-half of a short side of the rectangular shape. The length of the parallel section P2b is one-fourth of the length of one turn of the coil 30B. That is, the proportion of the path in the parallel section P2b to the path corresponding to one turn of the coil 30B is ¼ (0.25).

The same goes for the parallel section P1c, the parallel section P2c, the parallel section P1d, the parallel section P2d, and the parallel section P1e.

Referring to FIGS. 7 and 8, the proportion of the path in the first parallel section to the path corresponding to one turn of the coil 30B is not equal to the proportion of the path in the second parallel section to the path corresponding to one turn of the coil 30B (½ ¼) when the parallel section P1a and the parallel section P2a are the first parallel section and the second parallel section, respectively.

Referring to FIGS. 7 and 8, the proportion of the path in the first parallel section to the path corresponding to one turn of the coil 30B is equal to the proportion of the path in the third parallel section to the path corresponding to one turn of the coil 30B (½=½), and the proportion of the path in the second parallel section to the path corresponding to one turn of the coil 30B is equal to the proportion of the path in the fourth parallel section to the path corresponding to one turn of the coil 30B (¼=¼) when the parallel section P1a, the parallel section P2a, the parallel section P1b, and the parallel section P2b are the first parallel section, the second parallel section, the third parallel section, and the fourth parallel section, respectively.

### Third Embodiment

A multilayer coil component according to a third embodiment of the present disclosure is as follows: the proportion of the path in the first parallel section to the path corresponding to one turn of the coil is equal to the proportion of the path in the third parallel section to the path corresponding to one turn of the coil, and the proportion of the path in the second parallel section to the path corresponding to one turn of the coil is not equal to the proportion of the path in the fourth parallel section to the path corresponding to one turn of the coil. It is required that at least one group consisting of the first parallel section, the second parallel section, the third parallel section, and the fourth parallel section that have the aforementioned relationship be included in the multilayer coil component according to the third embodiment of the present disclosure.

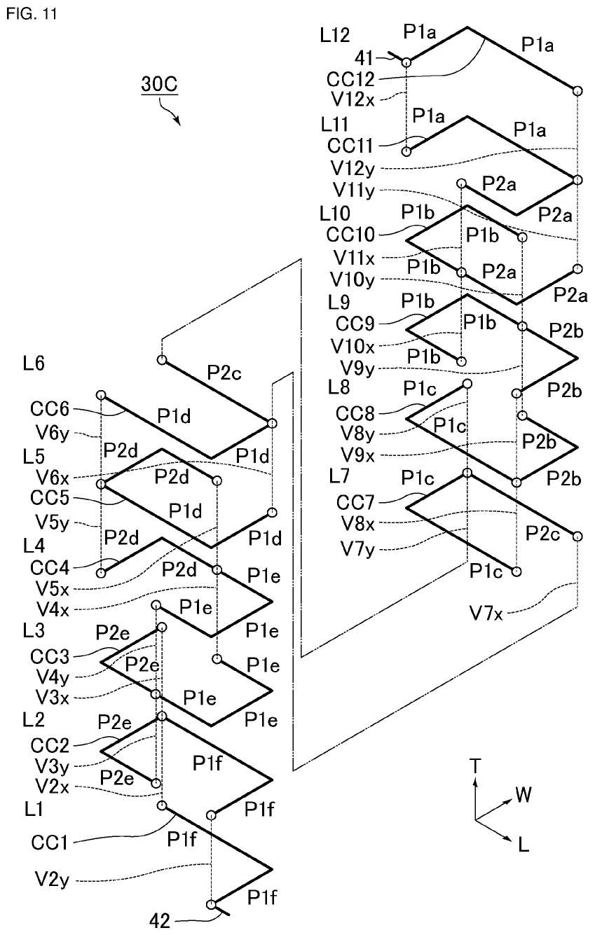

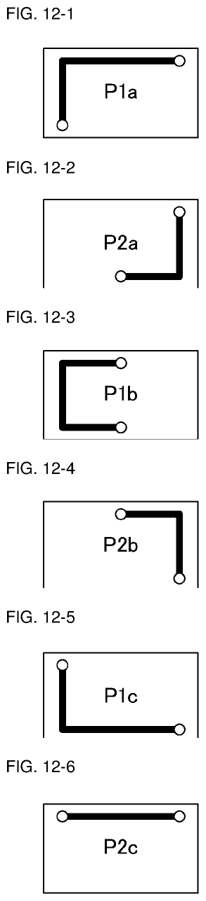

FIG. 10 is a schematic plan view of an example of a multilayer body included in the multilayer coil component according to the third embodiment of the present disclosure. FIG. 11 is an exploded perspective view of a coil embedded in the multilayer body in FIG. 10.

A multilayer body 10C is illustrated in FIG. 10 and includes a coil 30C, which is illustrated in FIG. 11 and embedded in the multilayer body 10C.

As with the multilayer body 10A illustrated in FIG. 2, the multilayer body 10C illustrated in FIG. 10 includes insulating layers stacked in the height direction T from its first main face toward its second main face. The insulating layers included in the multilayer body 10C are denoted by IL1, IL2, IL3, IL4, IL5, IL6, IL7, IL8, IL9, IL10, IL11, and IL12, respectively. The insulating layers IL1, IL2, IL3, IL4, IL5, IL6, IL7, IL8, IL9, IL10, IL11, and IL12 are hereinafter also collectively referred to as insulating layers IL.

Referring to FIG. 10, the insulating layers IL1, IL2, IL3, IL4, IL5, IL6, IL7, IL8, IL9, IL10, IL11, and IL12 are provided with coil conductors CC1, CC2, CC3, CC4, CC5, CC6, CC7, CC8, CC9, CC10, CC11, and CC12, each of which is disposed on the corresponding one of the insulating layers IL. The coil conductors CC1, CC2, CC3, CC4, CC5, CC6, CC7, CC8, CC9, CC10, CC11, and CC12 are hereinafter also collectively referred to as coil conductors CC.

The coil 30C illustrated in FIG. 11 is composed of the coil conductors CC stacked together with the insulating layers IL in layers in the stacking direction (i.e., the height direction T in the present embodiment) and electrically connected to each other.

In the example illustrated in FIGS. 10 and 11, the length of each of the coil conductors CC except for the coil conductors CC1, CC6, CC7, and CC12 is seven-eighths of one turn of the coil 30C. The length of each of the coil conductors CC1 and CC12 is one-half of one turn of the coil 30C, and the length of each of the coil conductors CC6 and CC7 is three-fourths of one turn of the coil 30C.

The insulating layer IL12 on a twelfth layer L12 is provided with via conductors V12x and V12y, which are provided to the respective ends of the coil conductor CC12.

The insulating layer IL11 on an eleventh layer L11 is provided with via conductor V11x and V11y, which are provided to an end of the coil conductor CC11 and a bent portion of the coil conductor CC11, respectively.

The insulating layer IL10 on a tenth layer L10 is provided with via conductor V10x and V10y, which are provided to a segment of the coil conductor CC10 and an end of the coil conductor CC10, respectively.

The insulating layer IL9 on a ninth layer L9 is provided with via conductors V9x and V9y, which are provided to an end of the coil conductor CC9 and a segment of the coil conductor CC9, respectively.

The insulating layer IL8 on an eighth layer L8 is provided with via conductor V8x and V8y, which are provided to a bent portion of the coil conductor CC8 and an end of the coil conductor CC8, respectively.

The insulating layer IL7 on a seventh layer L7 is provided with via conductor V7x and V7y, which are provided to an end of the coil conductor CC7 and a bent portion of the coil conductor CC7, respectively.

The insulating layer IL6 on a sixth layer L6 is provided with via conductor V6x and V6y, which are provided to a bent portion of the coil conductor CC6 and an end of the coil conductor CC6, respectively.

The insulating layer IL5 on a fifth layer L5 is provided with via conductor V5x and V5y, which are provided to an end of the coil conductor CC5 and a bent portion of the coil conductor CC5, respectively.

The insulating layer IL4 on a fourth layer L4 is provided with via conductor V4x and V4y, which are provided to a segment of the coil conductor CC4 and an end of the coil conductor CC4, respectively.

The insulating layer IL3 on a third layer L3 is provided with via conductor V3x and V3y, which are provided to an end of the coil conductor CC3 and a segment of the coil conductor CC3, respectively.

The insulating layer IL2 on a second layer L2 is provided with via conductor V2x and V2y, which are provided to a bent portion of the coil conductor CC2 and an end of the coil conductor CC2, respectively.

The via conductors V2x, V2y, V3x, V3y, V4x, V4y, V5x, V5y, V6x, V6y, V7x, V7y, V8x, V8y, V9x, V9y, V10x, V10y, V11x, V11y, V12x, and V12y are hereinafter also collectively referred to as via conductors V.

The insulating layers IL illustrated in FIG. 10 are stacked on top of one another in the height direction T such that the via conductors V each form an electrical connection between the coil conductors CC. Accordingly, the coil 30C in the multilayer body 10C is in the form of a solenoid having a coil axis extending in the height direction T, as illustrated in FIG. 11.

Referring to FIG. 10, an end portion of the coil conductor CC12 on the twelfth layer L12 is connected with an extended conductor 41, which is exposed at a first end face of the multilayer body 10C. The extended conductor 41 in the multilayer body 10C forms a connection between one of two outer electrodes and the coil conductor CC12.

Likewise, an end portion of the coil conductor CC1 on a first layer L1 is connected with an extended conductor 42, which is exposed at a second end face of the multilayer body 10C. The extended conductor 42 in the multilayer body 10C forms a connection between the other outer electrode and the coil conductor CC1.

The coil 30C includes a parallel section composed of two coil conductors CC that are stacked in layers and electrically connected in parallel by the via conductors V interposed therebetween. The parallel section includes a first parallel section and a second parallel section that is electrically connected in series with the first parallel section. The number of parallel sections included in the coil 30C is not limited to a particular value.

Referring to FIG. 11, a parallel section P1f, a parallel section P2e, a parallel section P1e, a parallel section P2d, a parallel section P1d, a parallel section P2c, a parallel section Plc, a parallel section P2b, a parallel section P1b, a parallel section P2a, and a parallel section P1a are arranged in sequence from the negative side toward the positive side in the height direction T. For example, the parallel section P1a is the first parallel section, and the parallel section P2a is the second parallel section. It is not required that the first parallel section be the parallel section P1a. The first parallel section be any one of the parallel sections P1a, P1b, P1c, P1d, and P1e.

The parallel section P1a is the region where the coil conductor CC12 on the twelfth layer L12 and part of the coil conductor CC11 on the eleventh layer L11 are electrically connected in parallel by the via conductors V12x and V12y interposed therebetween.

The parallel section P2a is the region where the coil conductor CC11 on the eleventh layer L11 and part of the coil conductor CC10 on the tenth layer L10 are electrically connected in parallel by the via conductors V11x and V11y interposed therebetween.

The parallel section P1b is the region where part of the coil conductor CC10 on the tenth layer L10 and part of the coil conductor CC9 on the ninth layer L9 are electrically connected in parallel by the via conductors V10x and V10y interposed therebetween.

The parallel section P2b is the region where part of the coil conductor CC9 on the ninth layer L9 and part of the coil conductor CC8 on the eighth layer L8 are electrically connected in parallel by the via conductors V9x and V9y interposed therebetween.

The parallel section Plc is the region where part of the coil conductor CC8 on the eighth layer L8 and part of the coil conductor CC7 on the seventh layer L7 are electrically connected in parallel by the via conductors V8x and V8y interposed therebetween.

The parallel section P2c is the region where part of the coil conductor CC7 on the seventh layer L7 and part of the coil conductor CC6 on the sixth layer L6 are electrically connected in parallel by the via conductors V7x and V7y interposed therebetween.

The parallel section P1d is the region where part of the coil conductor CC6 on the sixth layer L6 and part of the coil conductor CC5 on the fifth layer L5 are electrically connected in parallel by the via conductors V6x and V6y interposed therebetween.

The parallel section P2d is the region where part of the coil conductor CC5 on the fifth layer L5 and part of the coil conductor CC4 on the fourth layer L4 are electrically connected in parallel by the via conductors V5x and V5y interposed therebetween.

The parallel section P1e is the region where part of the coil conductor CC4 on the fourth layer L4 and part of the coil conductor CC3 on the third layer L3 are electrically connected in parallel by the via conductors V4x and V4y interposed therebetween.

The parallel section P2e is the region where part of the coil conductor CC3 on the third layer L3 and part of the coil conductor CC2 on the second layer L2 are electrically connected in parallel by the via conductors V3x and V3y interposed therebetween.

The parallel section P1f is the region where part of the coil conductor CC2 on the second layer L2 and the coil conductor CC1 on the first layer L1 are electrically connected in parallel by the via conductors V2x and V2y interposed therebetween.

As illustrated in FIGS. 10 and 11, one of the coil conductors CC included in the first parallel section and one of the coil conductors CC included in the second parallel section are connected directly to each other in one plane on a first insulating layer that is one of the insulating layers IL.

For example, the insulating layer IL11 on the eleventh layer L11 is the first insulating layer, provided that the parallel section P1a and the parallel section P2a are the first parallel section and the second parallel section, respectively. A portion being part of the coil conductor CC11 and included in the parallel section P1a and a portion being part of the coil conductor CC11 and included in the parallel section P2a are connected directly to each other in one plane on the insulating layer IL11 in the eleventh layer L11.

When viewed in the stacking direction (i.e., the height direction T in the present embodiment), the coil conductors CC lying on top of each other with the first insulating layer therebetween at least partially overlap each other in a region other than the parallel section in which the coil conductors CC lying on top of each other with the first insulating layer therebetween are connected in parallel and overlap each other.

For example, the parallel section P1a is the first parallel section, and the parallel section P2a is the second parallel section. When the coil conductors CC11 and CC10 lying on top of each other with the first insulating layer, namely, the insulating layer IL11 on the eleventh layer L11 therebetween are viewed in the height direction T, a portion being part of the coil conductor CC11 and included in the parallel section P1a and a portion being part of the coil conductor CC10 and included in the parallel section P1b overlap each other in a region other than the parallel section P2a in which the coil conductors CC11 and CC10 lying on top of each other with the insulating layer IL11 therebetween are connected in parallel and overlap each other.

The parallel section of the coil 30C may include, in addition to the first and second parallel sections, a third parallel section that is electrically connected in series with the second parallel section. For example, the parallel section P1b is the third parallel section, provided that the parallel section P1a and the parallel section P2a are the first parallel section and the second parallel section, respectively.

As illustrated in FIGS. 10 and 11, one of the coil conductors CC included in the second parallel section and one of the coil conductors CC included in the third parallel section are preferably connected directly to each other in one plane on a second insulating layer that is one of the insulating layers IL.

For example, the insulating layer IL10 on the tenth layer L10 is the second insulating layer, provided that the parallel section P1a, the parallel section P2a, and the parallel section P1b are the first parallel section, the second parallel section, and the third parallel section, respectively. A portion being part of the coil conductor CC10 and included in the parallel section P2a and a portion being part of the coil conductor CC10 and included in the parallel section P1b are connected directly to each other in one plane on the insulating layer IL10 in the tenth layer L10.

The parallel section of the coil 30C may include, in addition to the first, second, and third parallel sections, a fourth parallel section that is electrically connected in series with the third parallel section. For example, the parallel section P2b is the fourth parallel section, provided that the parallel section P1a, the parallel section P2a, and the parallel section P1b are the first parallel section, the second parallel section, and the third parallel section, respectively.

As illustrated in FIGS. 10 and 11, one of the coil conductors CC included in the third parallel section and one of the coil conductors CC included in the fourth parallel section are preferably connected directly to each other in one plane on a third insulating layer that is one of the insulating layers IL.

For example, the insulating layer IL9 on the ninth layer L9 is the third insulating layer, provided that the parallel section P1a, the parallel section P2a, the parallel section P1b, and the parallel section P2b are the first parallel section, the second parallel section, the third parallel section, and the fourth parallel section, respectively. A portion being part of the coil conductor CC9 and included in the parallel section P1b and a portion being part of the coil conductor CC9 and included in the parallel section P2b are connected directly to each other in one plane on the insulating layer IL9 in the ninth layer L9.

Referring to FIG. 11, the proportion of a path in the first parallel section to the path corresponding to one turn of the coil 30C is not equal to the proportion of a path in the second parallel section to the path corresponding to one turn of the coil 30C.

As described below, the rectangular shape of the coil 30C viewed in plan is equated with a square shape at the time when the proportion of the path in each parallel section is calculated.

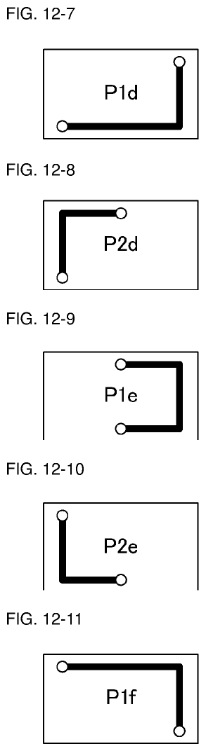

FIG. 12-1 is a schematic plan view of a path in the parallel section P1a of the coil 30C in FIG. 11.

The parallel section P1a has an L-shape including a short side and a long side of the rectangular shape. The length of the parallel section P1a is one-half of the length of one turn of the coil 30C. That is, the proportion of the path in the parallel section P1a to the path corresponding to one turn of the coil 30C is ½ (0.5).

FIG. 12-2 is a schematic plan view of a path in the parallel section P2a of the coil 30C in FIG. 11.

The parallel section P2a has an L-shape including a short side of the rectangular shape and one-half of a long side of the rectangular shape. The length of the parallel section P2a is three-eighths of the length of one turn of the coil 30C. That is, the proportion of the path in the parallel section P2a to the path corresponding to one turn of the coil 30C is ⅜ (0.375).

FIG. 12-3 is a schematic plan view of a path in the parallel section P1b of the coil 30C in FIG. 11.

The parallel section P1b has a square-cornered U-shape including one-half of one of two long sides of the rectangular shape, a short side of the rectangular shape, and one-half of the other long side of the rectangular shape. The length of the parallel section P1b is one-half of the length of one turn of the coil 30C. That is, the proportion of the path in the parallel section P1b to the path corresponding to one turn of the coil 30C is ½ (0.5).

FIG. 12-4 is a schematic plan view of a path in the parallel section P2b of the coil 30C in FIG. 11.

The parallel section P2b has an L-shape including one-half of a long side of the rectangular shape and a short side of the rectangular shape. The length of the parallel section P2b is three-eighths of the length of one turn of the coil 30C. That is, the proportion of the path in the parallel section P2b to the path corresponding to one turn of the coil 30C is ⅜ (0.375).

FIG. 12-5 is a schematic plan view of a path in the parallel section P1c of the coil 30C in FIG. 11.

The parallel section Plc has an L-shape including a long side and a short side of the rectangular shape. The length of the parallel section Plc is one-half of the length of one turn of the coil 30C. That is, the proportion of the path in the parallel section Plc to the path corresponding to one turn of the coil 30C is ½ (0.5).

FIG. 12-6 is a schematic plan view of a path in the parallel section P2c of the coil 30C in FIG. 11.

The parallel section P2c is in the form of a straight line including a long side of the rectangular shape. The length of the parallel section P2c is one-fourth of the length of one turn of the coil 30C. That is, the proportion of the path in the parallel section P2c to the path corresponding to one turn of the coil 30C is ¼ (0.25).

FIG. 12-7 is a schematic plan view of a path in the parallel section P1d of the coil 30C in FIG. 11.

The parallel section P1d has an L-shape including a short side and a long side of the rectangular shape. The length of the parallel section P1d is one-half of the length of one turn of the coil 30C. That is, the proportion of the path in the parallel section P1d to the path corresponding to one turn of the coil 30C is ½ (0.5).

FIG. 12-8 is a schematic plan view of a path in the parallel section P2d of the coil 30C in FIG. 11.

The parallel section P2d has an L-shape including a short side and a long side of the rectangular shape. The length of the parallel section P2d is three-eighths of the length of one turn of the coil 30C. That is, the proportion of the path in the parallel section P2d to the path corresponding to one turn of the coil 30C is ⅜ (0.375).

FIG. 12-9 is a schematic plan view of a path in the parallel section P1e of the coil 30C in FIG. 11.

The parallel section P1e has a square-cornered U-shape including one-half of one of two long sides of the rectangular shape, a short side of the rectangular shape, and one-half of the other long side of the rectangular shape. The length of the parallel section Pie is one-half of the length of one turn of the coil 30C. That is, the proportion of the path in the parallel section P1e to the path corresponding to one turn of the coil 30C is ½ (0.5).

FIG. 12-10 is a schematic plan view of a path in the parallel section P2e of the coil 30C in FIG. 11.

The parallel section P2e has an L-shape including one-half of a long side of the rectangular shape and a short side of the rectangular shape. The length of the parallel section P2e is three-eighths of the length of one turn of the coil 30C. That is, the proportion of the path in the parallel section P2e to the path corresponding to one turn of the coil 30C is ⅜ (0.375).

FIG. 12-11 is a schematic plan view of a path in the parallel section P1f of the coil 30C in FIG. 11.

The parallel section P1f has an L-shape including a long side and a short side of the rectangular shape. The length of the parallel section P1f is one-half of the length of one turn of the coil 30C. That is, the proportion of the path in the parallel section P1f to the path corresponding to one turn of the coil 30C is ½ (0.5).

Referring to FIGS. 10 and 11, the proportion of the path in the first parallel section to the path corresponding to one turn of the coil 30C is not equal to the proportion of the path in the second parallel section to the path corresponding to one turn of the coil 30C (½ ⅜) when the parallel section P1a and the parallel section P2a are the first parallel section and the second parallel section, respectively. The same holds true for the case where the parallel section P1b, P1d, or P1e is the first parallel section.

Referring to FIGS. 10 and 11, the proportion of the path in the first parallel section to the path corresponding to one turn of the coil 30C is not equal to the proportion of the path in the second parallel section to the path corresponding to one turn of the coil 30C (½ ¼) when the parallel section Plc and the parallel section P2c are the first parallel section and the second parallel section, respectively.

Referring to FIGS. 10 and 11, the proportion of the path in the first parallel section to the path corresponding to one turn of the coil 30C is equal to the proportion of the path in the third parallel section to the path corresponding to one turn of the coil 30C (½=½), and the proportion of the path in the second parallel section to the path corresponding to one turn of the coil 30C is equal to the proportion of the path in the fourth parallel section to the path corresponding to one turn of the coil 30C (⅜=⅜) when the parallel section P1a, the parallel section P2a, the parallel section P1b, and the parallel section P2b are the first parallel section, the second parallel section, the third parallel section, and the fourth parallel section, respectively. The same holds true for the case where the parallel section P1d, the parallel section P2d, the parallel section P1e, and the parallel section P2e are the first parallel section, the second parallel section, the third parallel section, and the fourth parallel section, respectively.

Referring to FIGS. 10 and 11, the proportion of the path in the first parallel section to the path corresponding to one turn of the coil 30C is equal to the proportion of the path in the third parallel section to the path corresponding to one turn of the coil 30C (½=½), and the proportion of the path in the second parallel section to the path corresponding to one turn of the coil 30C is not equal to the proportion of the path in the fourth parallel section to the path corresponding to one turn of the coil 30C (⅜ ¼) when the parallel section P1b, the parallel section P2b, the parallel section P1c, and the parallel section P2c are the first parallel section, the second parallel section, the third parallel section, and the fourth parallel section, respectively. The same holds true for the case where the parallel section P1c, the parallel section P2c, the parallel section P1d, and the parallel section P2d are the first parallel section, the second parallel section, the third parallel section, and the fourth parallel section, respectively.

### Fourth Embodiment

A multilayer coil component according to a fourth embodiment of the present disclosure is as follows: the proportion of the path in the first parallel section to the path corresponding to one turn of the coil is not equal to the proportion of the path in the third parallel section to the path corresponding to one turn of the coil, and the proportion of the path in the second parallel section to the path corresponding to one turn of the coil is not equal to the proportion of the path in the fourth parallel section to the path corresponding to one turn of the coil. It is required that at least one group consisting of the first parallel section, the second parallel section, the third parallel section, and the fourth parallel section that have the aforementioned relationship be included in the multilayer coil component according to the fourth embodiment of the present disclosure.

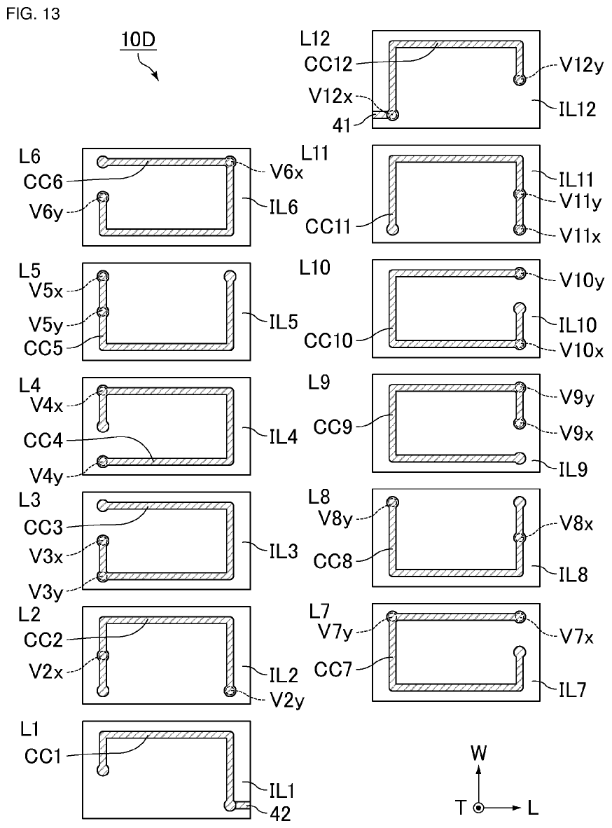

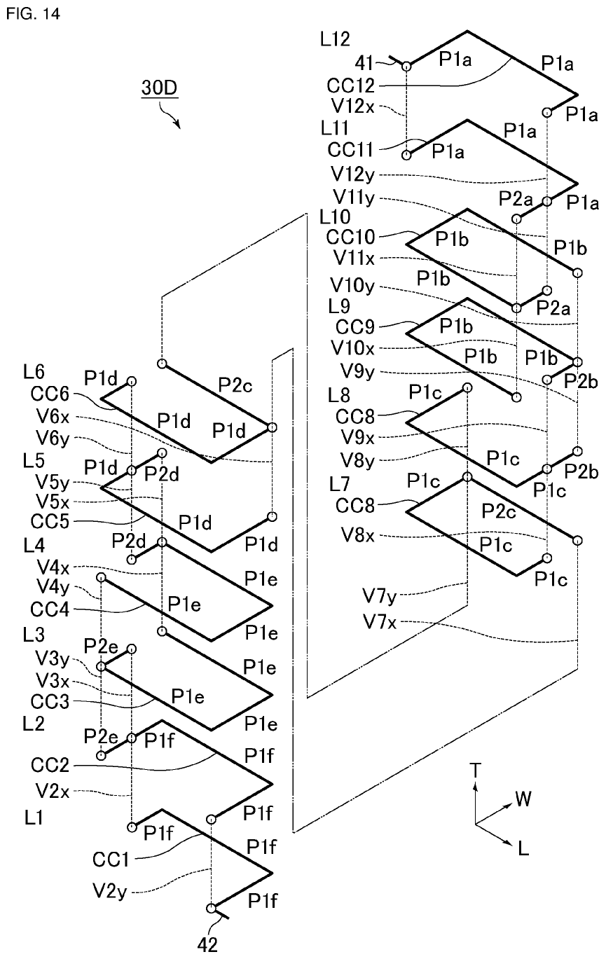

FIG. 13 is a schematic plan view of an example of a multilayer body included in the multilayer coil component according to the fourth embodiment of the present disclosure. FIG. 14 is an exploded perspective view of a coil embedded in the multilayer body in FIG. 13.

A multilayer body 10D is illustrated in FIG. 13 and includes a coil 30D, which is illustrated in FIG. 14 and embedded in the multilayer body 10D.

As with the multilayer body 10A illustrated in FIG. 2, the multilayer body 10D illustrated in FIG. 13 includes insulating layers stacked in the height direction T from its first main face toward its second main face. The insulating layers included the multilayer body 10D are denoted by IL1, IL2, R3, IL4, IL5, IL6, IL7, IL8, IL9, IL10, IL11, and IL12, respectively. The insulating layers IL1, IL2, IL3, IL4, IL5, IL6, IL7, IL8, IL9, IL10, IL11, and IL12 are hereinafter also collectively referred to as insulating layers IL.

Referring to FIG. 13, the insulating layers IL1, IL2, R3, IL4, IL5, IL6, IL7, IL8, IL9, IL10, IL11, and IL12 are provided with coil conductors CC1, CC2, CC3, CC4, CC5, CC6, CC7, CC8, CC9, CC10, CC11, and CC12, each of which is disposed on the corresponding one of the insulating layers IL. The coil conductors CC1, CC2, CC3, CC4, CC5, CC6, CC7, CC8, CC9, CC10, CC11, and CC12 are hereinafter also collectively referred to as coil conductors CC.

The coil 30D illustrated in FIG. 14 is composed of the coil conductors CC stacked together with the insulating layers IL in the stacking direction (i.e., the height direction T in the present embodiment) and electrically connected to each other.

In the example illustrated in FIGS. 13 and 14, the length of each of the coil conductors CC except for the coil conductors CC1, CC2, CC5, CC8, CC11, and CC12 is seven-eighths of one turn of the coil 30D. The length of each of the coil conductors CC1 and CC12 is five-eighths of one turn of the coil 30D, and the length of each of the coil conductors CC2, CC5, CC8, and CC11 is three-fourths of one turn of the coil 30D.

The insulating layer IL12 on a twelfth layer L12 is provided with via conductors V12x and V12y, which are provided to the respective ends of the coil conductor CC12.

The insulating layer IL11 on an eleventh layer L11 is provided with via conductor V11x and V11y, which are provided to an end of the coil conductor CC11 and a segment of the coil conductor CC11, respectively.

The insulating layer IL10 on a tenth layer L10 is provided with via conductor V10x and V10y, which are provided to a bent portion of the coil conductor CC10 and an end of the coil conductor CC10, respectively.

The insulating layer IL9 on a ninth layer L9 is provided with via conductors V9x and V9y, which are provided to an end of the coil conductor CC9 and a bent portion of the coil conductor CC9, respectively.

The insulating layer IL8 on an eighth layer L8 is provided with via conductor V8x and V8y, which are provided to a segment of the coil conductor CC8 and an end of the coil conductor CC8, respectively.

The insulating layer IL7 on a seventh layer L7 is provided with via conductor V7x and V7y, which are provided to an end of the coil conductor CC7 and a bent portion of the coil conductor CC7, respectively.

The insulating layer IL6 on a sixth layer L6 is provided with via conductor V6x and V6y, which are provided to a bent portion of the coil conductor CC6 and an end of the coil conductor CC6, respectively.

The insulating layer IL5 on a fifth layer L5 is provided with via conductor V5x and V5y, which are provided to an end of the coil conductor CC5 and a segment of the coil conductor CC5, respectively.

The insulating layer IL4 on a fourth layer L4 is provided with via conductor V4x and V4y, which are provided to a bent portion of the coil conductor CC4 and an end of the coil conductor CC4, respectively.

The insulating layer IL3 on a third layer L3 is provided with via conductor V3x and V3y, which are provided to an end of the coil conductor CC3 and a bent portion of the coil conductor CC3, respectively.

The insulating layer IL2 on a second layer L2 is provided with via conductor V2x and V2y, which are provided to a segment of the coil conductor CC2 and an end of the coil conductor CC2, respectively.

The via conductors V2x, V2y, V3x, V3y, V4x, V4y, V5x, V5y, V6x, V6y, V7x, V7y, V8x, V8y, V9x, V9y, V10x, V10y, V11x, V11y, V12x, and V12y are hereinafter also collectively referred to as via conductors V.

The insulating layers IL illustrated in FIG. 13 are stacked on top of one another in the height direction T such that the via conductors V each form an electrical connection between the coil conductors CC. Accordingly, the coil 30D in the multilayer body 10D is in the form of a solenoid having a coil axis extending in the height direction T, as illustrated in FIG. 14.

Referring to FIG. 13, an end portion of the coil conductor CC12 on the twelfth layer L12 is connected with an extended conductor 41, which is exposed at a first end face of the multilayer body 10D. The extended conductor 41 in the multilayer body 10D forms a connection between one of two outer electrodes and the coil conductor CC12.

Likewise, an end portion of the coil conductor CC1 on a first layer L1 is connected with an extended conductor 42, which is exposed at a second end face of the multilayer body 10D. The extended conductor 42 in the multilayer body 10D forms a connection between the other outer electrode and the coil conductor CC1.

The coil 30D includes a parallel section composed of two coil conductors CC that are stacked in layers and electrically connected in parallel by the via conductors V interposed therebetween. The parallel section includes a first parallel section and a second parallel section that is electrically connected in series with the first parallel section. The number of parallel sections included in the coil 30D is not limited to a particular value.

Referring to FIG. 14, a parallel section P1f, a parallel section P2e, a parallel section P1e, a parallel section P2d, a parallel section P1d, a parallel section P2c, a parallel section Plc, a parallel section P2b, a parallel section P1b, a parallel section P2a, and a parallel section P1a are arranged in sequence from the negative side toward the positive side in the height direction T. For example, the parallel section P1a is the first parallel section, and the parallel section P2a is the second parallel section. It is not required that the first parallel section be the parallel section P1a. The first parallel section be any one of the parallel sections P1a, P1b, P1c, P1d, and P1e.

The parallel section P1a is the region where the coil conductor CC12 on the twelfth layer L12 and part of the coil conductor CC11 on the eleventh layer L11 are electrically connected in parallel by the via conductors V12x and V12y interposed therebetween.

The parallel section P2a is the region where the coil conductor CC11 on the eleventh layer L11 and part of the coil conductor CC10 on the tenth layer L10 are electrically connected in parallel by the via conductors V11x and V11y interposed therebetween.

The parallel section P1b is the region where part of the coil conductor CC10 on the tenth layer L10 and part of the coil conductor CC9 on the ninth layer L9 are electrically connected in parallel by the via conductors V10x and V10y interposed therebetween.

The parallel section P2b is the region where part of the coil conductor CC9 on the ninth layer L9 and part of the coil conductor CC8 on the eighth layer L8 are electrically connected in parallel by the via conductors V9x and V9y interposed therebetween.

The parallel section Plc is the region where part of the coil conductor CC8 on the eighth layer L8 and part of the coil conductor CC7 on the seventh layer L7 are electrically connected in parallel by the via conductors V8x and V8y interposed therebetween.

The parallel section P2c is the region where part of the coil conductor CC7 on the seventh layer L7 and part of the coil conductor CC6 on the sixth layer L6 are electrically connected in parallel by the via conductors V7x and V7y interposed therebetween.

The parallel section P1d is the region where part of the coil conductor CC6 on the sixth layer L6 and part of the coil conductor CC5 on the fifth layer L5 are electrically connected in parallel by the via conductors V6x and V6y interposed therebetween.

The parallel section P2d is the region where part of the coil conductor CC5 on the fifth layer L5 and part of the coil conductor CC4 on the fourth layer L4 are electrically connected in parallel by the via conductors V5x and V5y interposed therebetween.

The parallel section P1e is the region where part of the coil conductor CC4 on the fourth layer L4 and part of the coil conductor CC3 on the third layer L3 are electrically connected in parallel by the via conductors V4x and V4y interposed therebetween.

The parallel section P2e is the region where part of the coil conductor CC3 on the third layer L3 and part of the coil conductor CC2 on the second layer L2 are electrically connected in parallel by the via conductors V3x and V3y interposed therebetween.

The parallel section P1f is the region where part of the coil conductor CC2 on the second layer L2 and the coil conductor CC1 on the first layer L1 are electrically connected in parallel by the via conductors V2x and V2y interposed therebetween.

As illustrated in FIGS. 13 and 14, one of the coil conductors CC included in the first parallel section and one of the coil conductors CC included in the second parallel section are connected directly to each other in one plane on a first insulating layer that is one of the insulating layers IL.

For example, the insulating layer IL11 on the eleventh layer L11 is the first insulating layer, provided that the parallel section P1a and the parallel section P2a are the first parallel section and the second parallel section, respectively. A portion being part of the coil conductor CC11 and included in the parallel section P1a and a portion being part of the coil conductor CC11 and included in the parallel section P2a are connected directly to each other in one plane on the insulating layer IL11 in the eleventh layer L11.

When viewed in the stacking direction (i.e., the height direction T in the present embodiment), the coil conductors CC lying on top of each other with the first insulating layer therebetween at least partially overlap each other in a region other than the parallel section in which the coil conductors CC lying on top of each other with the first insulating layer therebetween are connected in parallel and overlap each other.

For example, the parallel section P1a is the first parallel section, and the parallel section P2a is the second parallel section. When the coil conductors CC11 and CC10 lying on top of each other with the first insulating layer, namely, the insulating layer IL11 on the eleventh layer L11 therebetween are viewed in the height direction T, a portion being part of the coil conductor CC11 and included in the parallel section P1a and a portion being part of the coil conductor CC10 and included in the parallel section P1b overlap each other in a region other than the parallel section P2a in which the coil conductors CC11 and CC10 lying on top of each other with the insulating layer IL11 therebetween are connected in parallel and overlap each other.

The parallel section of the coil 30D may include, in addition to the first and second parallel sections, a third parallel section that is electrically connected in series with the second parallel section. For example, the parallel section P1b is the third parallel section, provided that the parallel section P1a and the parallel section P2a are the first parallel section and the second parallel section, respectively.

As illustrated in FIGS. 13 and 14, one of the coil conductors CC included in the second parallel section and one of the coil conductors CC included in the third parallel section are preferably connected directly to each other in one plane on a second insulating layer that is one of the insulating layers IL.

For example, the insulating layer IL10 on the tenth layer L10 is the second insulating layer, provided that the parallel section P1a, the parallel section P2a, and the parallel section P1b are the first parallel section, the second parallel section, and the third parallel section, respectively. A portion being part of the coil conductor CC10 and included in the parallel section P2a and a portion being part of the coil conductor CC10 and included in the parallel section P1b are connected directly to each other in one plane on the insulating layer IL10 in the tenth layer L10.

The parallel section of the coil 30D may include, in addition to the first, second, and third parallel sections, a fourth parallel section that is electrically connected in series with the third parallel section. For example, the parallel section P2b is the fourth parallel section, provided that the parallel section P1a, the parallel section P2a, and the parallel section P1b are the first parallel section, the second parallel section, and the third parallel section, respectively.

As illustrated in FIGS. 13 and 14, one of the coil conductors CC included in the third parallel section and one of the coil conductors CC included in the fourth parallel section are preferably connected directly to each other in one plane on a third insulating layer that is one of the insulating layers IL.

For example, the insulating layer IL9 on the ninth layer L9 is the third insulating layer, provided that the parallel section P1a, the parallel section P2a, the parallel section P1b, and the parallel section P2b are the first parallel section, the second parallel section, the third parallel section, and the fourth parallel section, respectively. A portion being part of the coil conductor CC9 and included in the parallel section P1b and a portion being part of the coil conductor CC9 and included in the parallel section P2b are connected directly to each other in one plane on the insulating layer IL9 in the ninth layer L9.

Referring to FIG. 14, the proportion of a path in the first parallel section to the path corresponding to one turn of the coil 30D is not equal to the proportion of a path in the second parallel section to the path corresponding to one turn of the coil 30D.

As described below, the rectangular shape of the coil 30D viewed in plan is equated with a square shape at the time when the proportion of the path in each parallel section is calculated.

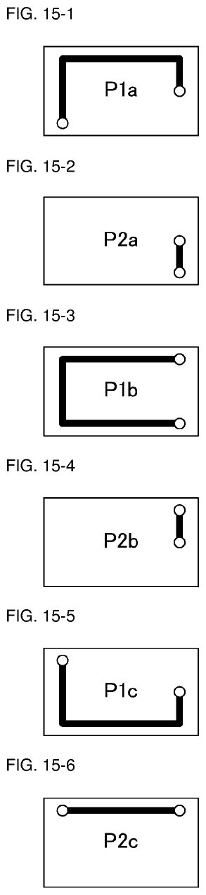

FIG. 15-1 is a schematic plan view of a path in the parallel section P1a of the coil 30D in FIG. 14.

The parallel section P1a has a square-cornered U-shape including one of two short sides of the rectangular shape, a long side of the rectangular shape, and one-half of the other short side of the rectangular shape. The length of the parallel section P1a is five-eighths of the length of one turn of the coil 30D. That is, the proportion of the path in the parallel section P1a to the path corresponding to one turn of the coil 30D is ⅝ (0.625).

FIG. 15-2 is a schematic plan view of a path in the parallel section P2a of the coil 30D in FIG. 14.

The parallel section P2a is in the form of a straight line including one-half of a short side of the rectangular shape. The length of the parallel section P2a is one-eighth of the length of one turn of the coil 30D. That is, the proportion of the path in the parallel section P2a to the path corresponding to one turn of the coil 30D is ⅛ (0.125).

FIG. 15-3 is a schematic plan view of a path in the parallel section P1b of the coil 30D in FIG. 14.

The parallel section P1b has a square-cornered U-shape including one of two long sides of the rectangular shape, a short side of the rectangular shape, and the other long side of the rectangular shape. The length of the parallel section P1b is three-fourths of the length of one turn of the coil 30D. That is, the proportion of the path in the parallel section P1b to the path corresponding to one turn of the coil 30D is ¾ (0.75).

FIG. 15-4 is a schematic plan view of a path in the parallel section P2b of the coil 30D in FIG. 14.

The parallel section P2b is in the form of a straight line including one-half of a short side of the rectangular shape. The length of the parallel section P2b is one-eighth of the length of one turn of the coil 30D. That is, the proportion of the path in the parallel section P2b to the path corresponding to one turn of the coil 30D is ⅛ (0.125).

FIG. 15-5 is a schematic plan view of a path in the parallel section P1c of the coil 30D in FIG. 14.

The parallel section P1c has a square-cornered U-shape including one-half of one of two short sides of the rectangular shape, a long side of the rectangular shape, and the other short side of the rectangular shape. The length of the parallel section Plc is five-eighths of the length of one turn of the coil 30D. That is, the proportion of the path in the parallel section Plc to the path corresponding to one turn of the coil 30D is ⅝ (0.625).

FIG. 15-6 is a schematic plan view of a path in the parallel section P2c of the coil 30D in FIG. 14.

The parallel section P2c is in the form of a straight line including a long side of the rectangular shape. The length of the parallel section P2c is one-fourth of the length of one turn of the coil 30D. That is, the proportion of the path in the parallel section P2c to the path corresponding to one turn of the coil 30D is ¼ (0.25).

FIG. 15-7 is a schematic plan view of a path in the parallel section P1d of the coil 30D in FIG. 14.

The parallel section P1d has a square-cornered U-shape including one of two short sides of the rectangular shape, a long side of the rectangular shape, and one-half of the other short side of the rectangular shape. The length of the parallel section P1d is five-eighths of the length of one turn of the coil 30D. That is, the proportion of the path in the parallel section P1d to the path corresponding to one turn of the coil 30D is ⅝ (0.625).

FIG. 15-8 is a schematic plan view of a path in the parallel section P2d of the coil 30D in FIG. 14.

The parallel section P2d is in the form of a straight line including one-half of a short side of the rectangular shape. The length of the parallel section P2d is one-eighth of the length of one turn of the coil 30D. That is, the proportion of the path in the parallel section P2d to the path corresponding to one turn of the coil 30D is ⅛ (0.125).

FIG. 15-9 is a schematic plan view of a path in the parallel section P1e of the coil 30D in FIG. 14.

The parallel section P1e has a square-cornered U-shape including one of two long sides of the rectangular shape, a short side of the rectangular shape, and the other long side of the rectangular shape. The length of the parallel section Pie is three-fourths of the length of one turn of the coil 30D. That is, the proportion of the path in the parallel section P1e to the path corresponding to one turn of the coil 30D is ¾ (0.75).

FIG. 15-10 is a schematic plan view of a path in the parallel section P2e of the coil 30D in FIG. 14.

The parallel section P2e is in the form of a straight line including one-half of a short side of the rectangular shape. The length of the parallel section P2e is one-eight of the length of one turn of the coil 30D. That is, the proportion of the path in the parallel section P2e to the path corresponding to one turn of the coil 30D is ⅛ (0.125).

FIG. 15-11 is a schematic plan view of a path in the parallel section P1f of the coil 30D in FIG. 14.

The parallel section P1f has a square-cornered U-shape including one-half of one of two short sides of the rectangular shape, a long side of the rectangular shape, and the other short side of the rectangular shape. The length of the parallel section P1f is five-eighths of the length of one turn of the coil 30D. That is, the proportion of the path in the parallel section P1f to the path corresponding to one turn of the coil 30D is ⅝ (0.625).

Referring to FIGS. 13 and 14, the proportion of the path in the first parallel section to the path corresponding to one turn of the coil 30D is not equal to the proportion of the path in the second parallel section to the path corresponding to one turn of the coil 30D (⅝ ⅛) when the parallel section P1a and the parallel section P2a are the first parallel section and the second parallel section, respectively. The same holds true for the case where the parallel section P1d is the first parallel section.

Referring to FIGS. 13 and 14, the proportion of the path in the first parallel section to the path corresponding to one turn of the coil 30D is not equal to the proportion of the path in the second parallel section to the path corresponding to one turn of the coil 30D (¾ ⅛) when the parallel section P1b and the parallel section P2b are the first parallel section and the second parallel section, respectively. The same holds true for the case where the parallel section P1e is the first parallel section.

Referring to FIGS. 13 and 14, the proportion of the path in the first parallel section to the path corresponding to one turn of the coil 30D is not equal to the proportion of the path in the second parallel section to the path corresponding to one turn of the coil 30D (⅝ ¼) when the parallel section Plc and the parallel section P2c are the first parallel section and the second parallel section, respectively.

Referring to FIGS. 13 and 14, the proportion of the path in the first parallel section to the path corresponding to one turn of the coil 30D is not equal to the proportion of the path in the third parallel section to the path corresponding to one turn of the coil 30D (⅝ ¾), and the proportion of the path in the second parallel section to the path corresponding to one turn of the coil 30D is equal to the proportion of the path in the fourth parallel section to the path corresponding to one turn of the coil 30D (⅛=⅛) when the parallel section P1a, the parallel section P2a, the parallel section P1b, and the parallel section P2b are the first parallel section, the second parallel section, the third parallel section, and the fourth parallel section, respectively. The same holds true for the case where the parallel section P1d, the parallel section P2d, the parallel section P1e, and the parallel section P2e are the first parallel section, the second parallel section, the third parallel section, and the fourth parallel section, respectively.

Referring to FIGS. 13 and 14, the proportion of the path in the first parallel section to the path corresponding to one turn of the coil 30D is equal to the proportion of the path in the third parallel section to the path corresponding to one turn of the coil 30D (¾ ⅝), and the proportion of the path in the second parallel section to the path corresponding to one turn of the coil 30D is not equal to the proportion of the path in the fourth parallel section to the path corresponding to one turn of the coil 30D (⅛ ¼) when the parallel section P1b, the parallel section P2b, the parallel section P1c, and the parallel section P2c are the first parallel section, the second parallel section, the third parallel section, and the fourth parallel section, respectively.

Referring to FIGS. 13 and 14, the proportion of the path in the first parallel section to the path corresponding to one turn of the coil 30D is equal to the proportion of the path in the third parallel section to the path corresponding to one turn of the coil 30D (⅝=⅝), and the proportion of the path in the second parallel section to the path corresponding to one turn of the coil 30D is not equal to the proportion of the path in the fourth parallel section to the path corresponding to one turn of the coil 30D (¼ ⅛) when the parallel section Plc, the parallel section P2c, the parallel section P1d, and the parallel section P2d are the first parallel section, the second parallel section, the third parallel section, and the fourth parallel section, respectively.

### Fifth Embodiment

A multilayer coil component according to a fifth embodiment of the present disclosure is a modification of a multilayer coil component according to the second embodiment of the present disclosure.

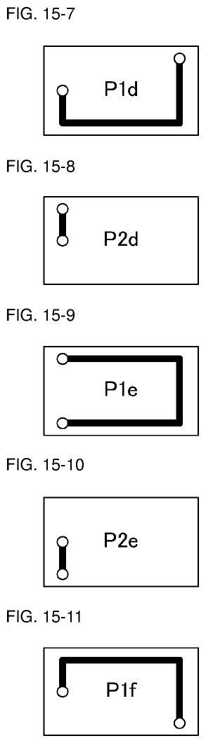

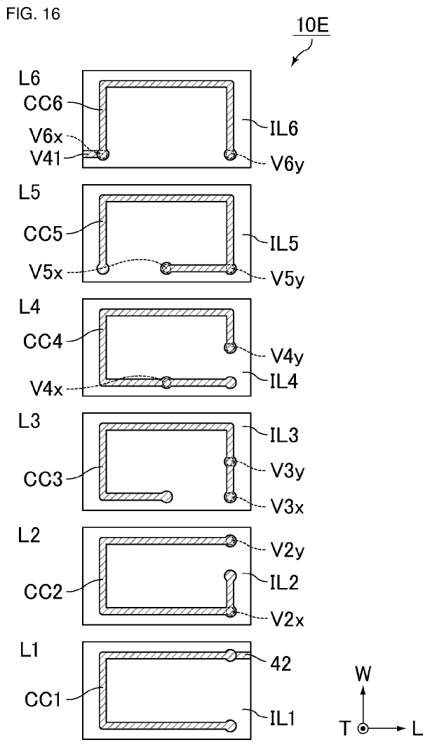

FIG. 16 is a schematic plan view of an example of a multilayer body included in the multilayer coil component according to the fifth embodiment of the present disclosure. FIG. 17 is an exploded perspective view of a coil embedded in the multilayer body in FIG. 16.

A multilayer body 10E is illustrated in FIG. 16 and includes a coil 30E, which is illustrated in FIG. 17 and embedded in the multilayer body 10E.

As with the multilayer body 10A illustrated in FIG. 2, the multilayer body 10E illustrated in FIG. 16 includes insulating layers stacked in the height direction T from its first main face toward its second main face. The insulating layers included in the multilayer body 10E are denoted by IL1, IL2, IL3, IL4, IL5, and IL6, respectively. The insulating layers IL1, IL2, IL3, IL4, IL5, and IL6 are hereinafter also collectively referred to as insulating layers IL.

Referring to FIG. 16, the insulating layers IL1, IL2, IL3, IL4, IL5, and IL6 are provided with coil conductors CC1, CC2, CC3, CC4, CC5, and CC6, each of which is disposed on the corresponding one of the insulating layers IL. The coil conductors CC1, CC2, CC3, CC4, CC5, and CC6 are hereinafter also collectively referred to as coil conductors CC.

The coil 30E illustrated in FIG. 17 is composed of the coil conductors CC stacked together with the insulating layers IL in the stacking direction (i.e., the height direction T in the present embodiment) and electrically connected to each other.

In the example illustrated in FIGS. 16 and 17, the length of each of the coil conductors CC except for the coil conductors CC1 and CC6 is seven-eighths of one turn of the coil 30E. The length of each of the coil conductors CC1 and CC6 is three-fourths of one turn of the coil 30E.

The insulating layer IL6 on a sixth layer L6 is provided with via conductor V6x and V6y, which are provided to the respective ends of the coil conductor CC6.

The insulating layer IL5 on a fifth layer L5 is provided with via conductor V5x and V5y, which are provided to an end of the coil conductor CC5 and a bent portion of the coil conductor CC5, respectively.

The insulating layer IL4 on a fourth layer L4 is provided with via conductor V4x and V4y, which are provided to a segment of the coil conductor CC4 and an end of the coil conductor CC4, respectively.

The insulating layer IL3 on a third layer L3 is provided with via conductor V3x and V3y, which are provided to an end of the coil conductor CC3 and a segment of the coil conductor CC3, respectively.

The insulating layer IL2 on a second layer L2 is provided with via conductor V2x and V2y, which are provided to a bent portion of the coil conductor CC2 and an end of the coil conductor CC2, respectively.

The via conductors V2x, V2y, V3x, V3y, V4x, V4y, V5x, V5y, V6x, and V6y are hereinafter also collectively referred to as via conductors V.

The insulating layers IL illustrated in FIG. 16 are stacked on top of one another in the height direction T such that the via conductors V each form an electrical connection between the coil conductors CC. Accordingly, the coil 30E in the multilayer body 10E is in the form of a solenoid having a coil axis extending in the height direction T, as illustrated in FIG. 17.

Referring to FIG. 16, an end portion of the coil conductor CC6 on the sixth layer L6 is connected with an extended conductor 41, which is exposed at a first end face of the multilayer body 10E. The extended conductor 41 in the multilayer body 10E forms a connection between one of two outer electrodes and the coil conductor CC6.

Likewise, an end portion of the coil conductor CC1 on a first layer L1 is connected with an extended conductor 42, which is exposed at a second end face of the multilayer body 10E. The extended conductor 42 in the multilayer body 10E forms a connection between the other outer electrode and the coil conductor CC1.

The coil 30E includes a parallel section composed of two coil conductors CC that are stacked in layers and electrically connected in parallel by the via conductors V interposed therebetween. The parallel section includes a first parallel section and a second parallel section that is electrically connected in series with the first parallel section. The number of parallel sections included in the coil 30E is not limited to a particular value.

Referring to FIG. 17, a parallel section P1c, a parallel section P2b, a parallel section P1b, a parallel section P2a, and a parallel section P1a are arranged in sequence from the negative side toward the positive side in the height direction T. For example, the parallel section P1a is the first parallel section, and the parallel section P2a is the second parallel section. It is not required that the first parallel section be the parallel section P1a. The first parallel section be one of the parallel sections P1a and P1b.

The parallel section P1a is the region where the coil conductor CC6 on the sixth layer L6 and part of the coil conductor CC5 on the fifth layer L5 are electrically connected in parallel by the via conductors V6x and V6y interposed therebetween.

The parallel section P2a is the region where part of the coil conductor CC5 on the fifth layer L5 and part of the coil conductor CC4 on the fourth layer L4 are electrically connected in parallel by the via conductors V5x and V5y interposed therebetween.

The parallel section P1b is the region where part of the coil conductor CC4 on the fourth layer L4 and part of the coil conductor CC3 on the third layer L3 are electrically connected in parallel by the via conductors V4x and V4y interposed therebetween.

The parallel section P2b is the region where part of the coil conductor CC3 on the third layer L3 and part of the coil conductor CC2 on the second layer L2 are electrically connected in parallel by the via conductors V3x and V3y interposed therebetween.

The parallel section Plc is the region where part of the coil conductor CC2 on the second layer L2 and the coil conductor CC1 on the first layer L1 are electrically connected in parallel by the via conductors V2x and V2y interposed therebetween.

As illustrated in FIGS. 16 and 17, one of the coil conductors CC included in the first parallel section and one of the coil conductors CC included in the second parallel section are connected directly to each other in one plane on a first insulating layer that is one of the insulating layers IL.

For example, the insulating layer IL5 on the fifth layer L5 is the first insulating layer, provided that the parallel section P1a and the parallel section P2a are the first parallel section and the second parallel section, respectively. A portion being part of the coil conductor CC5 and included in the parallel section P1a and a portion being part of the coil conductor CC5 and included in the parallel section P2a are connected directly to each other in one plane on the insulating layer IL5 in the fifth layer L5.

When viewed in the stacking direction (i.e., the height direction T in the present embodiment), the coil conductors CC lying on top of each other with the first insulating layer therebetween at least partially overlap each other in a region other than the parallel section in which the coil conductors CC lying on top of each other with the first insulating layer therebetween are connected in parallel and overlap each other.

For example, the parallel section P1a is the first parallel section, and the parallel section P2a is the second parallel section. When the coil conductors CC5 and CC4 lying on top of each other with the first insulating layer, namely, the insulating layer IL5 on the fifth layer L5 therebetween are viewed in the height direction T, a portion being part of the coil conductor CC5 and included in the parallel section P1a and a portion being part of the coil conductor CC4 and included in the parallel section P1b overlap each other in a region other than the parallel section P2a in which the coil conductors CC5 and CC4 lying on top of each other with the insulating layer IL5 therebetween are connected in parallel and overlap each other.

The parallel section of the coil 30E may include, in addition to the first and second parallel sections, a third parallel section that is electrically connected in series with the second parallel section. For example, the parallel section P1b is the third parallel section, provided that the parallel section P1a and the parallel section P2a are the first parallel section and the second parallel section, respectively.

As illustrated in FIGS. 16 and 17, one of the coil conductors CC included in the second parallel section and one of the coil conductors CC included in the third parallel section are preferably connected directly to each other in one plane on a second insulating layer that is one of the insulating layers IL.

For example, the insulating layer IL4 on the fourth layer L4 is the second insulating layer, provided that the parallel section P1a, the parallel section P2a, and the parallel section P1b are the first parallel section, the second parallel section, and the third parallel section, respectively. A portion being part of the coil conductor CC4 and included in the parallel section P2a and a portion being part of the coil conductor CC4 and included in the parallel section P1b are connected directly to each other in one plane on the insulating layer IL4 in the fourth layer L4.

The parallel section of the coil 30E may include, in addition to the first, second, and third parallel sections, a fourth parallel section that is electrically connected in series with the third parallel section. For example, the parallel section P2b is the fourth parallel section, provided that the parallel section P1a, the parallel section P2a, and the parallel section P1b are the first parallel section, the second parallel section, and the third parallel section, respectively.

As illustrated in FIGS. 16 and 17, one of the coil conductors CC included in the third parallel section and one of the coil conductors CC included in the fourth parallel section are preferably connected directly to each other in one plane on a third insulating layer that is one of the insulating layers IL.

For example, the insulating layer IL3 on the third layer L3 is the third insulating layer, provided that the parallel section P1a, the parallel section P2a, the parallel section P1b, and the parallel section P2b are the first parallel section, the second parallel section, the third parallel section, and the fourth parallel section, respectively. A portion being part of the coil conductor CC3 and included in the parallel section P1b and a portion being part of the coil conductor CC3 and included in the parallel section P2b are connected directly to each other in one plane on the insulating layer IL3 in the third layer L3.

Referring to FIG. 17, the proportion of a path in the first parallel section to the path corresponding to one turn of the coil 30E is not equal to the proportion of a path in the second parallel section to the path corresponding to one turn of the coil 30E.

As described below, the rectangular shape of the coil 30E viewed in plan is equated with a square shape at the time when the proportion of the path in each parallel section is calculated.

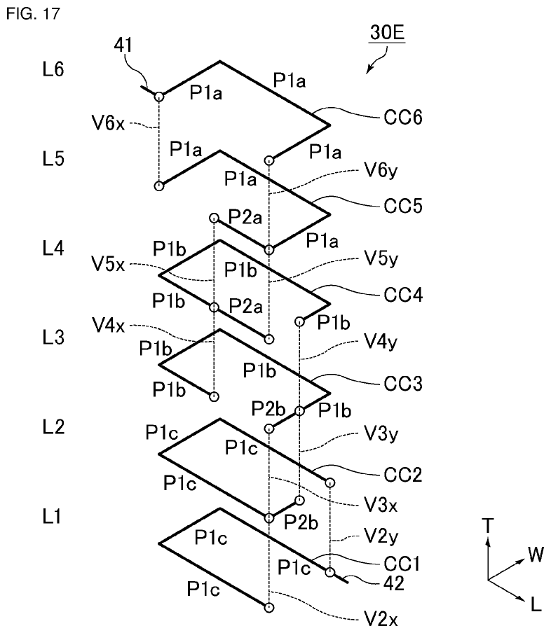

FIG. 18-1 is a schematic plan view of a path in the parallel section P1a of the coil 30E in FIG. 17.

The parallel section P1a has a square-cornered U-shape including one of two short sides of the rectangular shape, a long side of the rectangular shape, and the other short side of the rectangular shape. The length of the parallel section P1a is three-fourths of the length of one turn of the coil 30E. That is, the proportion of the path in the parallel section P1a to the path corresponding to one turn of the coil 30E is ¾ (0.75).

FIG. 18-2 is a schematic plan view of a path in the parallel section P2a of the coil 30E in FIG. 17.

The parallel section P2a is in the form of a straight line including one-half of a long side of the rectangular shape. The length of the parallel section P2a is one-eighth of the length of one turn of the coil 30E. That is, the proportion of the path in the parallel section P2a to the path corresponding to one turn of the coil 30E is ⅛ (0.125).

FIG. 18-3 is a schematic plan view of a path in the parallel section P1b of the coil 30E in FIG. 17.

The parallel section P1b has a shape including one-half of one of two long sides of the rectangular shape, one of two short sides of the rectangular shape, the other long side of the rectangular shape, and one-half of the other short side of the rectangular shape. The length of the parallel section P1b is three-fourths of the length of one turn of the coil 30E. That is, the proportion of the path in the parallel section P1b to the path corresponding to one turn of the coil 30E is ¾ (0.75).

FIG. 18-4 is a schematic plan view of a path in the parallel section P2b of the coil 30E in FIG. 17.

The parallel section P2b is in the form of a straight line including one-half of a short side of the rectangular shape. The length of the parallel section P2b is one-eighth of the length of one turn of the coil 30E. That is, the proportion of the path in the parallel section P2b to the path corresponding to one turn of the coil 30E is ⅛ (0.125).

FIG. 18-5 is a schematic plan view of a path in the parallel section P1c of the coil 30E in FIG. 17.

The parallel section Plc has a square-cornered U-shape including one of two long sides of the rectangular shape, a short side of the rectangular shape, and the other long side of the rectangular shape. The length of the parallel section Plc is three-fourths of the length of one turn of the coil 30E. That is, the proportion of the path in the parallel section Plc to the path corresponding to one turn of the coil 30E is ¾ (0.75).

Referring to FIGS. 16 and 17, the proportion of the path in the first parallel section to the path corresponding to one turn of the coil 30E is not equal to the proportion of the path in the second parallel section to the path corresponding to one turn of the coil 30E (¾ ⅛) when the parallel section P1a and the parallel section P2a are the first parallel section and the second parallel section, respectively.

Referring to FIGS. 16 and 17, the proportion of the path in the first parallel section to the path corresponding to one turn of the coil 30E is equal to the proportion of the path in the third parallel section to the path corresponding to one turn of the coil 30E (¾=¾), and the proportion of the path in the second parallel section to the path corresponding to one turn of the coil 30E is equal to the proportion of the path in the fourth parallel section to the path corresponding to one turn of the coil 30E (⅛=⅛) when the parallel section P1a, the parallel section P2a, the parallel section P1b, and the parallel section P2b are the first parallel section, the second parallel section, the third parallel section, and the fourth parallel section, respectively.

### Other Embodiments

The multilayer coil component according to the present disclosure is not limited to the embodiments described above; provided that one of the coil conductors included in the first parallel section and one of the coil conductors included in the second parallel section are connected directly to each other in one plane on the first insulating layer that is one of the insulating layers, and the coil conductors lying on top of each other with the first insulating layer therebetween and viewed in the stacking direction at least partially overlap each other in a region other than the parallel section in which the coil conductors lying on top of each other with the first insulating layer therebetween are connected in parallel and overlap each other. With regard to, for example, the configuration of the multilayer coil component and conditions for producing the multilayer coil component, various applications and alterations are possible within the scope of the present disclosure.

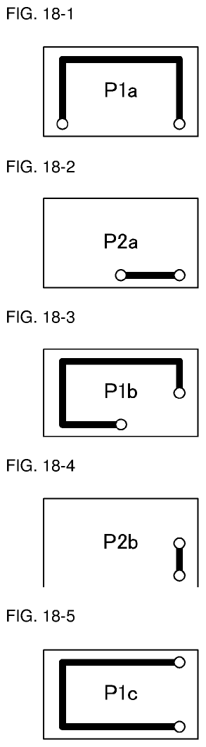

FIG. 19 is a schematic development view of an example of a coil included in a multilayer coil component according to another embodiment of the present disclosure.

Referring to FIG. 19, a first parallel section P1 and a second parallel section P2 are each composed of three coil conductors, and one of the coil conductors CC included in the first parallel section P1 and one of the coil conductors CC included in the second parallel section P2 are disposed on the same insulating layer (not illustrated), in which case a maximum of three via conductors V are disposed on top of each other with no other via conductors interposed therebetween in the stacking direction.

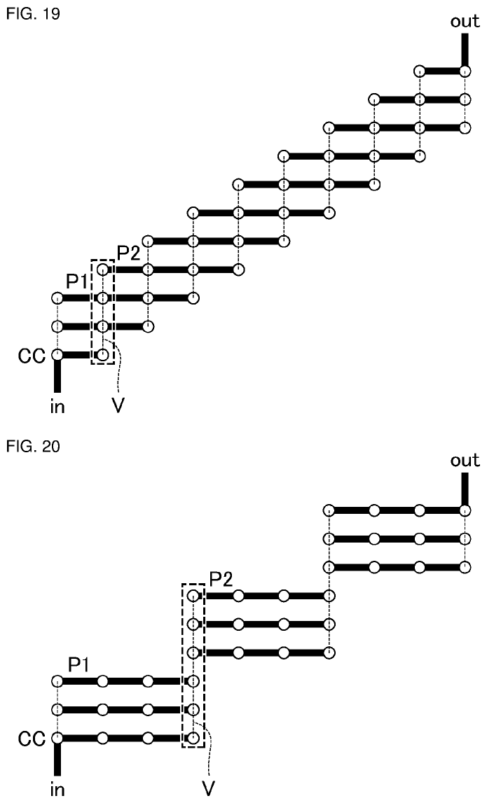

FIG. 20 is a schematic development view of another example of the coil included in the conventional multilayer coil component.

Referring to FIG. 20, a first parallel section P1 and a second parallel section P2 are each composed of three coil conductors, and every part of each coil conductor CC included in the first parallel section P1 and every part of each coil conductor CC included in the second parallel section P2 are not located on the same insulating layer (not illustrated), in which case a maximum of five via conductors V are disposed on top of each other with no other via conductors interposed therebetween in the stacking direction.

As can be understood from a comparison of FIG. 19 to FIG. 20, the number of via conductors V disposed on top of each other in the stacking direction can be reduced by the present embodiment, in which one of the coil conductors CC included in the first parallel section P1 and one of the coil conductors CC included in the second parallel section P2 are located on the same insulating layer.

The details of the present disclosure disclosed herein are as follows.

<1> A multilayer coil component including a multilayer body including insulating layers and a coil, the insulating layers being stacked on top of one another in the stacking direction, a coil being embedded in the multilayer body; and outer electrodes disposed on an outer surface of the multilayer body and electrically connected to the coil. The coil is composed of coil conductors stacked together with the insulating layers in the stacking direction and electrically connected to each other. The coil includes a parallel section in which two or more of the coil conductors stacked in layers are electrically connected in parallel by via conductors interposed therebetween. The parallel section includes a first parallel section and a second parallel section that is electrically connected in series with the first parallel section. One of the coil conductors included in the first parallel section and one of the coil conductors included in the second parallel section are connected directly to each other in one plane on a first insulating layer that is one of the insulating layers. When viewed in the stacking direction, the coil conductors lying on top of each other with the first insulating layer therebetween at least partially overlap each other in a region other than the parallel section in which the coil conductors lying on top of each other with the first insulating layer therebetween are connected in parallel and overlap each other.

<2> The multilayer coil component according to <1>, wherein a proportion of a path in the first parallel section to a path corresponding to one turn of the coil is not equal to a proportion of a path in the second parallel section to the path corresponding to one turn of the coil.

<3> The multilayer coil component according to <1> or <2>, wherein the parallel section includes, in addition to the first and second parallel sections, a third parallel section that is electrically connected in series with the second parallel section. Also, one of the coil conductors included in the second parallel section and one of the coil conductors included in the third parallel section are connected directly to each other in one plane on a second insulating layer that is one of the insulating layers.

<4> The multilayer coil component according to <3>, wherein the parallel section includes, in addition to the first, second, and third parallel sections, a fourth parallel section that is electrically connected in series with the third parallel section. Also, one of the coil conductors included in the third parallel section and one of the coil conductors included in the fourth parallel section are connected directly to each other in one plane on a third insulating layer that is one of the insulating layers.

<5> The multilayer coil component according to <4>, wherein a proportion of a path in the first parallel section to a path corresponding to one turn of the coil is not equal to a proportion of a path in the second parallel section to the path corresponding to one turn of the coil, and a proportion of a path in the third parallel section to the path corresponding to one turn of the coil is not equal to a proportion of a path in the fourth parallel section to the path corresponding to one turn of the coil.

<6> The multilayer coil component according to <5>, wherein the proportion of the path in the first parallel section to the path corresponding to one turn of the coil is equal to the proportion of the path in the third parallel section to the path corresponding to one turn of the coil, and the proportion of the path in the second parallel section to the path corresponding to one turn of the coil is equal to the proportion of the path in the fourth parallel section to the path corresponding to one turn of the coil.

<7> The multilayer coil component according to <5>, wherein the proportion of the path in the first parallel section to the path corresponding to one turn of the coil is equal to the proportion of the path in the third parallel section to the path corresponding to one turn of the coil, and the proportion of the path in the second parallel section to the path corresponding to one turn of the coil is not equal to the proportion of the path in the fourth parallel section to the path corresponding to one turn of the coil.

<8> The multilayer coil component according to <5>, wherein the proportion of the path in the first parallel section to the path corresponding to one turn of the coil is not equal to the proportion of the path in the third parallel section to the path corresponding to one turn of the coil, and the proportion of the path in the second parallel section to the path corresponding to one turn of the coil is not equal to the proportion of the path in the fourth parallel section to the path corresponding to one turn of the coil.

<9> The multilayer coil component according to any one of <2>, <5>, <6>, <7>, and <8>, wherein the proportion of the path in the first parallel section to the path corresponding to one turn of the coil is more than or equal to 0.4 and less than or equal to 0.8, and the proportion of the path in the second parallel section to the path corresponding to one turn of the coil is more than or equal to 0.1 and less than 0.4 (i.e., from 0.1 to less than 0.4).

<10> The multilayer coil component according to any one of <1> to <9>, wherein the coil conductors each have a segment that is not part of a bent portion and that is connected with at least one of the via conductors.

<11> The multilayer coil component according to any one of <1> to <10>, wherein the first parallel section and the second parallel section included in the parallel section are each composed of two of the coil conductors stacked in layers.

<12> The multilayer coil component according to any one of <1> to <11>, wherein a maximum of two of the via conductors are disposed on top of each other with no other via conductors interposed therebetween in the stacking direction.

<13> The multilayer coil component according to any one of <1> to <12>, wherein a coil conductor being one of the coil conductors in the first parallel section and not disposed on the first insulating layer and a coil conductor being one of the coil conductors in the second parallel section and not disposed on the first insulating layer are disposed on different ones of the insulating layers.

<14> The multilayer coil component according to <13>, wherein the parallel section includes, in addition to the first and second parallel sections, a third parallel section that is electrically connected in series with the second parallel section. One of the coil conductors included in the second parallel section and one of the coil conductors included in the third parallel section are connected directly to each other in one plane on a second insulating layer that is one of the insulating layers. A coil conductor is one of the coil conductors in the second parallel section and not disposed on the second insulating layer and a coil conductor is one of the coil conductors in the third parallel section and not disposed on the second insulating layer are disposed on different ones of the insulating layers.

<15> The multilayer coil component according to any one of <1> to <14>, wherein the first parallel section and the second parallel section do not overlap each other when viewed in the stacking direction.

<16> The multilayer coil component according to <15>, wherein the parallel section includes, in addition to the first and second parallel sections, a third parallel section that is electrically connected in series with the second parallel section. One of the coil conductors included in the second parallel section and one of the coil conductors included in the third parallel section are connected directly to each other in one plane on a second insulating layer that is one of the insulating layers, and the second parallel section and the third parallel section do not overlap each other when viewed in the stacking direction.

### EXAMPLES

The multilayer coil component according to the present disclosure is more specifically described below by way of examples. The following examples should not be construed as limiting the scope of the present disclosure.

The structure of multilayer coil components prepared as samples in Example is as illustrated in FIG. 7.

The structure of multilayer coil components prepared as samples in Comparative Example is as illustrated in FIG. 6.

A total of 100 samples in Example and a total of 100 samples in Comparative Example were vertically disposed and set in resin, where their respective faces (WT faces) extending in the width direction W and the height direction T were exposed to view. The samples were then trimmed with a grinder until substantially the midsection of each sample in the length direction L was exposed. The surface exposed by the grinding process was observed under a digital microscope to see if there was any crack.

The observations revealed that all of the samples (100 out of 100) in Comparative Example had cracks developed toward the surfaces of the respective base bodies (the side gap), whereas none of the samples (0 out of 100) in Example had such a crack.

What is claimed is:

1. A multilayer coil component comprising:
a multilayer body including insulating layers and a coil, the insulating layers being stacked on top of one another in a stacking direction, and the coil being embedded in the multilayer body; and
outer electrodes on an outer surface of the multilayer body and electrically connected to the coil, wherein
the coil includes coil conductors stacked together with the insulating layers in the stacking direction and electrically connected to each other,
the coil includes a parallel section in which two or more of the coil conductors stacked in layers are electrically connected in parallel by via conductors interposed therebetween,
the parallel section includes a first parallel section and a second parallel section that is electrically connected in series with the first parallel section,
one of the coil conductors included in the first parallel section and one of the coil conductors included in the second parallel section are connected directly to each other in one plane on a first insulating layer that is one of the insulating layers, and
when viewed in the stacking direction, the coil conductors lying on top of each other with the first insulating layer therebetween at least partially overlap each other in a region other than the parallel section in which the coil conductors lying on top of each other with the first insulating layer therebetween are connected in parallel and overlap each other.

2. The multilayer coil component according to claim 1, wherein
a proportion of a path in the first parallel section to a path corresponding to one turn of the coil is not equal to a proportion of a path in the second parallel section to the path corresponding to one turn of the coil.

3. The multilayer coil component according to claim 1, wherein
the parallel section includes, in addition to the first and second parallel sections, a third parallel section that is electrically connected in series with the second parallel section, and
one of the coil conductors included in the second parallel section and one of the coil conductors included in the third parallel section are connected directly to each other in one plane on a second insulating layer that is one of the insulating layers.

4. The multilayer coil component according to claim 3, wherein
the parallel section includes, in addition to the first, second, and third parallel sections, a fourth parallel section that is electrically connected in series with the third parallel section, and
one of the coil conductors included in the third parallel section and one of the coil conductors included in the fourth parallel section are connected directly to each other in one plane on a third insulating layer that is one of the insulating layers.

5. The multilayer coil component according to claim 4, wherein
a proportion of a path in the first parallel section to a path corresponding to one turn of the coil is not equal to a proportion of a path in the second parallel section to the path corresponding to one turn of the coil, and
a proportion of a path in the third parallel section to the path corresponding to one turn of the coil is not equal to a proportion of a path in the fourth parallel section to the path corresponding to one turn of the coil.

6. The multilayer coil component according to claim 5, wherein
the proportion of the path in the first parallel section to the path corresponding to one turn of the coil is equal to the proportion of the path in the third parallel section to the path corresponding to one turn of the coil, and
the proportion of the path in the second parallel section to the path corresponding to one turn of the coil is equal to the proportion of the path in the fourth parallel section to the path corresponding to one turn of the coil.

7. The multilayer coil component according to claim 5, wherein
the proportion of the path in the first parallel section to the path corresponding to one turn of the coil is equal to the proportion of the path in the third parallel section to the path corresponding to one turn of the coil, and
the proportion of the path in the second parallel section to the path corresponding to one turn of the coil is not equal to the proportion of the path in the fourth parallel section to the path corresponding to one turn of the coil.

8. The multilayer coil component according to claim 5, wherein
the proportion of the path in the first parallel section to the path corresponding to one turn of the coil is not equal to the proportion of the path in the third parallel section to the path corresponding to one turn of the coil, and
the proportion of the path in the second parallel section to the path corresponding to one turn of the coil is not equal to the proportion of the path in the fourth parallel section to the path corresponding to one turn of the coil.

9. The multilayer coil component according to claim 2, wherein
the proportion of the path in the first parallel section to the path corresponding to one turn of the coil is from 0.4 to 0.8, and
the proportion of the path in the second parallel section to the path corresponding to one turn of the coil is from 0.1 to less than 0.4.

10. The multilayer coil component according to claim 1, wherein
the coil conductors each have a segment that is not part of a bent portion and that is connected with at least one of the via conductors.

11. The multilayer coil component according to claim 1, wherein
the first parallel section and the second parallel section included in the parallel section are each composed of two of the coil conductors stacked in layers.

12. The multilayer coil component according to claim 11, wherein
a maximum of two of the via conductors are on top of each other with no other via conductors interposed therebetween in the stacking direction.

13. The multilayer coil component according to claim 12, wherein
a coil conductor being one of the coil conductors in the first parallel section and not on the first insulating layer and a coil conductor being one of the coil conductors in the second parallel section and not on the first insulating layer are on different ones of the insulating layers.

14. The multilayer coil component according to claim 13, wherein
the parallel section includes, in addition to the first and second parallel sections, a third parallel section that is electrically connected in series with the second parallel section,
one of the coil conductors included in the second parallel section and one of the coil conductors included in the third parallel section are connected directly to each other in one plane on a second insulating layer that is one of the insulating layers, and
a coil conductor being one of the coil conductors in the second parallel section and not on the second insulating layer and a coil conductor being one of the coil conductors in the third parallel section and not on the second insulating layer are on different ones of the insulating layers.

15. The multilayer coil component according to claim 12, wherein
the first parallel section and the second parallel section do not overlap each other when viewed in the stacking direction.

16. The multilayer coil component according to claim 15, wherein
the parallel section includes, in addition to the first and second parallel sections, a third parallel section that is electrically connected in series with the second parallel section,
one of the coil conductors included in the second parallel section and one of the coil conductors included in the third parallel section are connected directly to each other in one plane on a second insulating layer that is one of the insulating layers, and
the second parallel section and the third parallel section do not overlap each other when viewed in the stacking direction.

17. The multilayer coil component according to claim 5, wherein
the proportion of the path in the first parallel section to the path corresponding to one turn of the coil is from 0.4 to 0.8, and
the proportion of the path in the second parallel section to the path corresponding to one turn of the coil is from 0.1 to less than 0.4.

18. The multilayer coil component according to claim 6, wherein
the proportion of the path in the first parallel section to the path corresponding to one turn of the coil is from 0.4 to 0.8, and
the proportion of the path in the second parallel section to the path corresponding to one turn of the coil is from 0.1 to less than 0.4.

19. The multilayer coil component according to claim 2, wherein
the coil conductors each have a segment that is not part of a bent portion and that is connected with at least one of the via conductors.

20. The multilayer coil component according to claim 2, wherein
the first parallel section and the second parallel section included in the parallel section are each composed of two of the coil conductors stacked in layers.
